(19) United States
(12) Patent Application Publication
(10) Pub. No.: US 2011/0014351 A1
(43) Pub. Date: Jan. 20, 2011

(54) SYSTEM AND METHOD FOR PROVIDING A PERSONALIZED DAILY NUTRITIONAL SUPPLEMENT PACKAGE

(75) Inventors: Carroll REIDER, Northridge, CA (US); Larry Bacharach, Northridge, CA (US); Eric Co, Northridge, CA (US)

Correspondence Address: VENABLE LLP, P.O. BOX 34385, WASHINGTON, DC, 20043-9998, US

(73) Assignee: Pharmavite Direct, LLC, Northridge, CA (US)

(21) Appl. No.: 12/837,210

(22) Filed: Jul. 15, 2010

Related U.S. Application Data
(60) Provisional application No. 61/225,826, filed on Jul. 15, 2009.

(51) Int. Cl. G06Q 50/00; A23L 1/30; B65B 1/04; B65B 5/06

(52) U.S. Cl. 426/648; 705/2; 53/473; 53/202

(57) ABSTRACT

A computer-implemented method, apparatus, system, and packaging for providing a daily nutritional supplement component regimen, comprising a series of daily packets each containing dosage forms selected by a series of answers to questions provided by a consumer.

### CROSS REFERENCE TO RELATED APPLICATIONS

This patent application claims priority to U.S. Provisional Application No. 61/225,826, filed Jul. 15, 2009, which is incorporated by reference, to the extent allowed by local law.

### BACKGROUND

The field of the invention relates to a customized solution to nutritional needs using dietary supplements including vitamins, minerals, and herbals in a dynamic online environment that meets the consumers' unique nutritional needs without exceeding recommended upper limits on nutrients.

Various systems for recommending vitamins have previously been described. For example, U.S. Pat. Nos. 5,954,640, 6,510,430, and 7,136,820 as well as U.S. Published Patent Application No. 2005/0240085 disclose exemplary systems. Additionally, other systems are available commercially. Each of these systems has disadvantages. They may ask too many extraneous questions, recommend too many nutrients, fail to take into consideration a full range of personal health factors, fail to take into consideration the current state of science on dietary supplements, be overly complex, or be inefficient. They may be confusing and rely on the consumer to make a decision about what supplements to take, without the benefit of a nutritionist's expertise. Or they may rely on unproven science, such as DNA testing. Also, they may not be customized to the individual.

### SUMMARY

Aspects of the invention involve methods, machines, and products. The invention employs a specially designed and easy to use consumer survey/questionnaire, and a scientifically developed nutritional algorithm based on nutritional health science, to efficiently provide personalized daily vitamin recommendations, and daily vitamin packs containing the recommended supplements.

One objective of the invention is to provide a vitamin program that is customized to an individual's unique needs. The customized vitamin recommendations may be based on leading nutritional science and take into account a person's diet, gender, age, exercise, lifestyle, medications used, allergies, and surrounding environmental factors. The recommendation may also take into account daily vitamin dosages. The personalized vitamins are then sorted and packed in individual re-sealable pouches for daily use.

For nutrients to be beneficial a person needs the right nutrient in an appropriate amount. A person who takes too little of a nutrient supplement will not reap the benefits of that nutrient. A person also wants to avoid taking too much of a nutrient, and avoid taking any nutrient that is not needed. The inventive system meets that need and provides the amount that will be beneficial. The inventive system reduces consumer guesswork and provides the person with a nutrient selection unique to them.

In an exemplary embodiment of the invention, a computer-implemented method for providing a daily nutritional supplement component regimen comprises: creating, at a first computer, a plurality of questions, each question regarding a health condition of a user, each question having at least two possible answers, each answer representing a qualitative or quantitative characteristic of the user's health condition, each health condition linked to a set of at least one predetermined recommended nutritional supplement components; presenting the plurality of questions to the user on a second computer; receiving at the first computer a user response to the plurality of questions, the first computer accepting one and only one response to each question; identifying an original group of predetermined recommended nutritional supplement components at the first computer, each recommended nutritional supplement component being associated with a health condition of the user; identifying at least one recommended nutritional supplement dosage form at the first computer based on the plurality of recommended nutritional supplement components; and providing the user with a list of the at least one recommended nutritional supplement dosage form to the second computer.

In another exemplary embodiment of the invention, an apparatus comprises: one or more of a computer input devices operable to receive data; a storage device operable to maintain a question-answer-nutritional supplement map; a processor configured to generate a dietary supplement regimen in response to answers to health condition questions provided at the input device, the regimen including a plurality of nutritional supplement components, each component being associated with a particular health condition; and an output device configured to deliver the regimen.

In another exemplary embodiment of the invention, a non-transitory computer-readable storage medium with an executable program stored thereon, wherein the program instructs a microprocessor to perform the following steps of generating a dietary supplement regimen: creating, at a first computer, a plurality of questions, each question regarding a health condition of a user, each question having at least two possible answers, each answer representing a qualitative or quantitative characteristic of the user's health condition, each health condition linked to a set of at least one predetermined recommended nutritional supplement components; presenting the plurality of questions to the user on a second computer via the input device; receiving at the first computer a user response to the plurality of questions, the first computer accepting one and only one response to each question; identifying an original group of predetermined recommended nutritional supplement components at the first computer, each recommended nutritional supplement component being associated with a health condition of the user; and identifying at least one recommended nutritional supplement dosage form at the first computer based on the plurality of recommended nutritional supplement components.

In embodiments of the invention, the algorithm is updated periodically to include survey questions, answers, and nutritional supplement component recommendations in line with the latest in nutritional science.

The survey questions and answers may be designed in an easy-to-understand format that does not allow for error in the basis for recommendations.

The packaging machinery and overall fulfillment system may run using Good Manufacturing Practices (GMP) for quality to ensure that the consumer receives the exact vitamin recommendation deriving from the survey responses.

The inventive system can ensure that the consumer understands all implications of the recommendation, and knows to update their responses as needed, e.g. when there are changes in diet, lifestyle, medications, etc. The system permits a person to chat with an expert as needed.

Some of the valuable features of the invention's structure, composition, process, and/or operation are as follows.
The computational, packaging, and fulfillment systems and subsystems of the invention permit effective use of an algorithm based on extensive scientific research and nutritional expertise and logic.
The inventive system is effective to translate scientific knowledge held by professional nutritionists into automated customized recommendations and packages.
The invention makes use of efficiencies of the internet using a website user interface to provide a user-friendly environment for a consumer to (a) take the health survey, (b) obtain a customized recommendation based on operation of the computerized automated nutritional algorithm processor and related equipment, (c) purchase a supply of personalized dietary supplement packs, and (d) to receive a package prepared and shipped securely, accurately, and economically.
The particular dosage forms, combining various vitamin and nutritional supplement components, can be designed to fit efficiently with the range of recommendations to be made, so as to minimize the number of pills that a consumer may need to take in a day, and to meet demands for pills within certain size ranges (e.g., pills that are too large or small).
The unique packaging of the end-product includes a personalized outer box, chosen by the customer, to reduce the likelihood of confusion between multiple consumers in one household; a removable drawer box, containing a long-term (e.g. 28 day) supply of daily packets, each of which is resealable to permit the consumer to take the pills over the course of a day; and for refills, the ability to send a replacement drawer box. Alternatively, a refill of daily packets may be shipped to the user without being contained in a drawer box. Upon receipt, the user may place the daily packets into a drawer box the user previously purchased.

In other embodiments, the system may include the following features:
Consumer Feedback (blogging, ratings, reviews, comments, pictures);
Mobile (e.g. IPhone) applications (health survey, recommendations, health tracker);
Daily reminder and update Widgets (reminders to take vitamins, health tips);
Ability to determine when a package will be, or has been, shipped;
Ability to preorder more than one 4 week supply at a time; and
Fully customizable packaging (design your own packaging).

Further features of the invention, as well as the structure and operation of various embodiments, are described in detail below with reference to the accompanying drawings.

### BRIEF DESCRIPTION OF THE DRAWINGS/APPENDICES

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 depicts an exemplary system 100 for use with an exemplary method of providing a personalized, daily nutritional supplement package.

FIG. 2 depicts an exemplary map 200 of an exemplary algorithm.

FIG. 3 depicts an exemplary map 300 of an exemplary algorithm.

FIG. 4 depicts an exemplary map 400 of an exemplary algorithm.

FIG. 5 depicts an exemplary flowchart for an exemplary method for providing a personalized, daily nutritional supplement package.

FIG. 6 depicts an exemplary system 600 for assembling a personalized, daily nutritional supplement package.

FIG. 7 depicts an exemplary computer system.

FIGS. 8A-8H contains various exemplary website layouts.

FIGS. 9A-9EE contain an exemplary questionnaire.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “may be” and the like, are meant to include, but not be limited to, the listed examples.

A “nutritional supplement component” (hereinafter referred to as ‘a component’) may refer to any individual compound intended to benefit a potential user, as distinguished from multiple components, as in a multivitamin dosage form. Examples of components are well known and include individual vitamins (such as A, the B vitamins, C, D, E, and K), minerals (such as calcium and iron), herbs and plant material (such as saw palmetto and gingko biloba), animal products (such as fish oil), and possibly over-the-counter medicines.

A “nutritional supplement dosage form” (hereinafter referred to as ‘a dosage form’) may refer to a manufactured item which combines one or more components and is intended for human consumption. Examples of dosage forms are well understood in the art and include liquids, pills, capsules, tablets, and gel capsules.

A “responsive component” may refer to the identity of a nutritional supplement component that addresses one or more specific health conditions possessed by an exemplary user.

A “responsive dosage” may refer to a nutritional supplement dosage form that addresses one or more specific health conditions possessed by an exemplary user.

A “dietary restriction” may refer to a limitation on an exemplary user's ability or willingness to ingest a specific compound. Examples of dietary restrictions include health concerns, moral concerns, allergies, vegetarian status, vegan status, and user preference.

In an exemplary embodiment of the invention, a computer and mechanical system and method may provide a personalized, daily nutritional supplement package. Daily packages can be assembled into weekly, monthly, or yearly nutritional supplement packaging, or packaging for other suitable durations. Alternatives to daily packages could include multiple daily packages, or packages to be taken less frequently than daily e.g. every other day.

According to the invention, a nutritional survey/questionnaire may be created. The survey/questionnaire may be founded upon a knowledge base containing, for example, a dossier of scientific literature relating to nutrition. The questionnaire may contain a series of questions relating to a number of user health/physical/lifestyle conditions.

Health and physical conditions may include, for example, a user's over all health, eye health, respiratory health, mood/emotional well-being, memory/retention, ability to sleep, skin health, and joint health. Health conditions may include for example age, gender, allergies, family history, medical history, calcium intake, vitamin D intake, the eating habits of the user, the alcohol consumption of the user, the sugar consumption of the user, the softdrink consumption of the user, the caffeine consumption of the user, medications taken by the user, and the dietary restrictions of the user. For women, they may also include pregnancy, lactation, experience with premenstrual symptoms (women under 50), or premenopausal or menopausal symptoms (women over 50), and concerns for breast and urinary health. For men, they may include urinary health, and prostate health.

Lifestyle conditions include for example exercise, cardiovascular or strength training, exposure to air pollution, sunlight, smoke, second hand smoke, or stress. Lifestyle conditions may include dietary habits such as eating habits, alcohol consumption, sugar consumption, soft drink consumption, caffeine consumption, amount of sleep, and dietary restrictions

The system and method of the invention may involve creating a “quasi-decision tree” algorithm and questionnaire based on the knowledge base. The “quasi-decision tree” algorithm may, for example, operate on predetermined and concrete, complete and consistent data. The data which may be contained in the knowledge base may, for example, be based on established and accepted principles developed and calculated prior to, and independently of, any specific customer interaction or input. The data may include information relating to the impact of specific components and/or dosage forms on various health conditions. Each answer to each question may be linked to one of the available components and/or dosage forms. This linkage can minimize the number of questions a consumer must answer, and the number of dosage forms to be provided. Answers to each question may be linked to one or more of the available supplement components and may be used in determining if the customer receives a particular supplement component.

A computer system may receive answers to the nutritional survey and use the “quasi-decision tree” algorithm to translate user responses to the survey into customized recommendations for nutritional supplementation by associating a specific type and amount of a supplement to an answer for certain enumerated questions. The algorithm may be developed based on research contained in a separate dossier database.

According to the invention, a customer may access the system via the World Wide Web. The customer/user may then complete a questionnaire and health assessment by providing health and nutritional status information relating to the customer through the internet, e.g. on the customer's own computer.

In an exemplary embodiment, after the questionnaire is completed and submitted, e.g. to the dietary supplement provider's server network, the customer's answers may be processed to provide a customized recommendation for nutritional supplementation, e.g. using the “quasi-decision tree” algorithm to arrive at the recommended personalized, daily nutritional supplement package.

Each personalized daily package may be part of a recommended nutritional regimen and contain a plurality of dosage forms. The recommended nutritional regimen may comprise a plurality of personalized daily packages. In an exemplary embodiment, the plurality of personalized daily packages do not each contain the same number of dosage forms. In addition to dosage forms, the recommended nutritional regimen may contain diet and exercise recommendations

In an exemplary embodiment, the “quasi-decision tree” algorithm, and, therefore, the survey, covers, for example, the customer's age, gender, family history, environmental factors, diet, prescription medication, and allergies. The recommendations are sensitive to, for example, daily allowable maximum limits, dietary restrictions, and include corrections for allergens, for a violation of a maximum daily allowable intake, and/or for fish oil amounts. The method of the invention may involve reducing pill count through combination products, selection an appropriate multivitamin, and a final override for non/nearly-non participation, such as surgery or pregnancy.

Once identified, the recommended personalized daily nutritional supplement package may help the customer maximize long-term optimal health and/or address specific issues that relate to one or more health concerns.

In an exemplary embodiment, based on the answers to the questionnaire and the assessment of those answers, the customer immediately receives a recommendation for a personalized, daily nutritional supplement package and may receive Condition Specific Pack Add-on recommendation(s). Information may also be displayed regarding the scientific basis for the recommendation including the contents of the packets, the dosage of the supplements, and the cost of each packet.

In an exemplary embodiment, after being provided with the recommendation, the customer may choose (1) not to buy any daily package, (2) to purchase the recommended daily package only, (3) to purchase the recommended daily package and one or more of the Condition Specific Packs, (4) to purchase some, but not all, of the dosage forms in the recommended daily package, and/or (5) to purchase additional dosage forms which were not specifically recommended. The customer may select the recommended package and/or add-on recommendation(s) on a shopping cart screen. The customer may then see the price and tax for each package of supplements. The customer may then select a shipping method, a supplement package quantity (for example, a 1, 2, 3, 4, 5, or 6 month supply), and purchases the supplement package, e.g. by credit card. The customer may also select the number and frequency of auto shipments on the shopping cart screen. Auto shipments may refer to the date upon which a specified supplement package quantity will be shipped to the customer. An auto shipment may be shipped such that it arrives close to or on the day the customer is anticipated to run out of a previously purchased supplement package.

Price and tax may be displayed after the pack selection(s) have been made. In addition, each packet may be individually priced or they may be priced in groups. All daily packages may be priced independent of the type and/or quantity of dosages contained therein. Alternatively, a daily package containing only, for example, but not limited to, 1, 2, or 3 dosage form(s) may be charged at a lower rate than those dosage forms containing, for example, but not limited to, 4 or more dosage forms. Each specific add-on condition packet may have a different cost depending on the ingredients. In some embodiments, there are no supplement or dosage amounts listed at the shopping cart stage, since the amounts were previously displayed. If purchased, the packets are shipped to arrive e.g. 1 to 10 business days later. The shipping costs are factored into the cost of the product. Customers may place auto reorders so that they would not have to re-order every month.

Once the supplement package(s) is received, the user may consume the dosage forms contained in the package e.g. at home, or at work, in a non-clinical environment. That is, the user may obtain and consume the dietary supplements without securing a prescription and does not need to or be under the supervision of a doctor or any other medical professional.

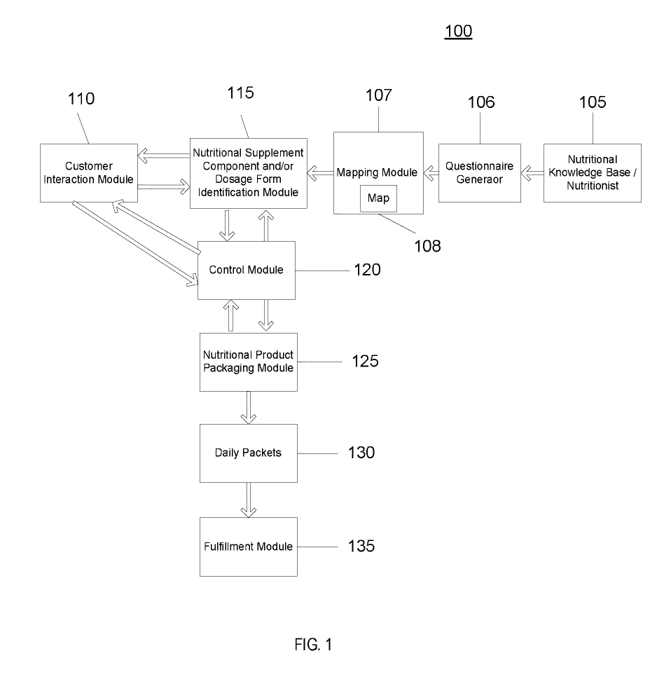

FIG. 1 depicts an exemplary system 100 for use with an exemplary method of providing a personalized, daily nutritional supplement package. The exemplary system 100 may be comprised of, for example, a nutritional knowledge base module 105, a questionnaire module 106, Mapping module 107, a customer interaction module 110, a nutritional supplement component and/or dosage form identification module 115 (hereinafter ‘identification module 115’), a control module 120, a packaging module 125, and a finished product e.g. in the form of daily packets.

Nutritional knowledge base 105 may include one or more specific nutritional knowledge base. An exemplary nutritional knowledge base may be based on established and accepted principles. Exemplary principles may relate to, for example, the effect nutritional components have on the human body, ways in which nutritional components may prevent/cure/treat human health conditions and/or lifestyle conditions, the interactions between nutritional components and medicines, and the nutritional components which comprise a healthy diet for a person of a certain sex, age, and health status. An exemplary nutritional knowledge base may be created and/or maintained, directly or indirectly, by a nutritionist, a dietician, and/or any other health professional.

Questionnaire module 106 may generate a health questionnaire (hereinafter a ‘questionnaire’). An exemplary questionnaire may contain a series of questions based on an exemplary nutritional knowledge base module 105. Each exemplary question in an exemplary questionnaire may be associated with one or more health condition an exemplary user may or may not have. The exemplary question may be associated with at least two responsive answers. Each answer may be associated with the relevant health condition and/or with at least one exemplary pre-selected, responsive component or at least one exemplary responsive dosage form. A responsive component and/or dosage form may be a component or dosage form which supplies the user with an appropriate level of nutritional supplementation based on, for example, the responsive answer and the nutritional knowledge base.

In an exemplary embodiment, the questionnaire may associate at least one exemplary responsive answer with at least one preferred pre-selected, responsive component(s) or dosage form(s) and at least one substitute pre-selected, responsive component(s) or dosage form(s). The substitute pre-selected, responsive component(s) or dosage form(s) may be utilized in the event the preferred pre-selected, responsive component(s) or dosage form(s) violates a dietary restriction of the user.

Exemplary responsive answers may be, for example, binary answers (e.g., yes or no), answers selected from a plurality of available answers (e.g., a drop-down menu), or by filling in a blank. An exemplary questionnaire may be found in appendix A, which is discussed further below.

In an exemplary embodiment, the questionnaire may be prepared, directly or indirectly, by a nutritionist, a dietician, and/or any other health professional based on the knowledge base 105. In addition, the questionnaire may be prepared, in whole or in part, by a computer program or a computer system using information contained in nutritional knowledge base 105.

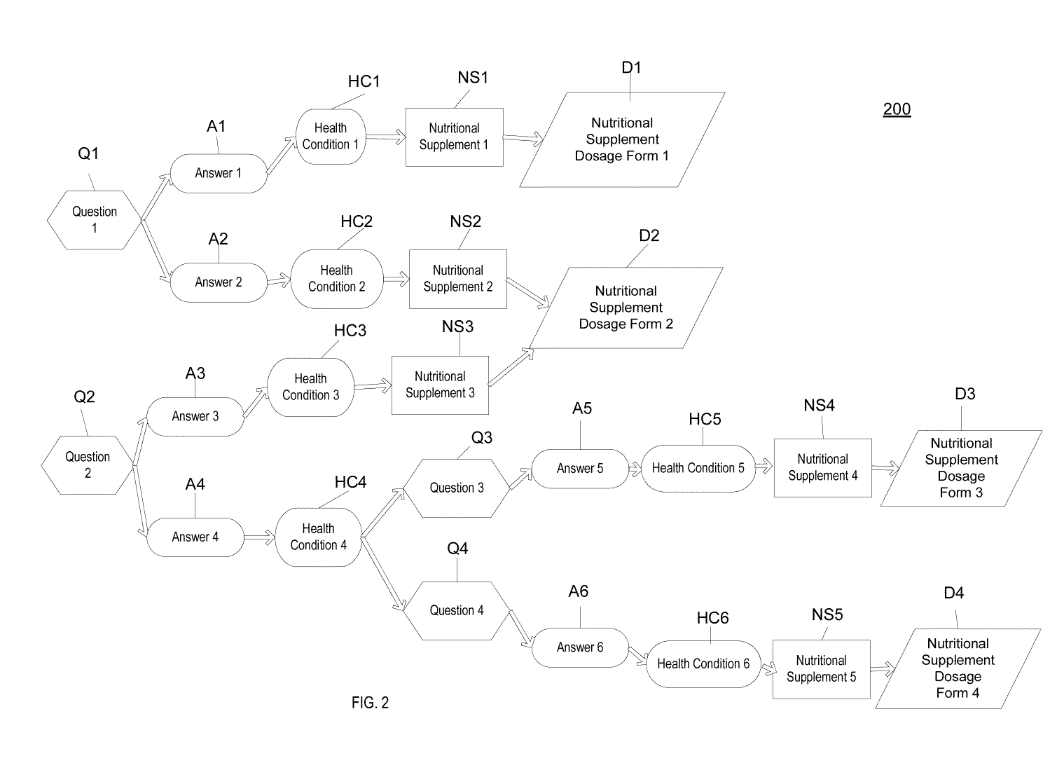

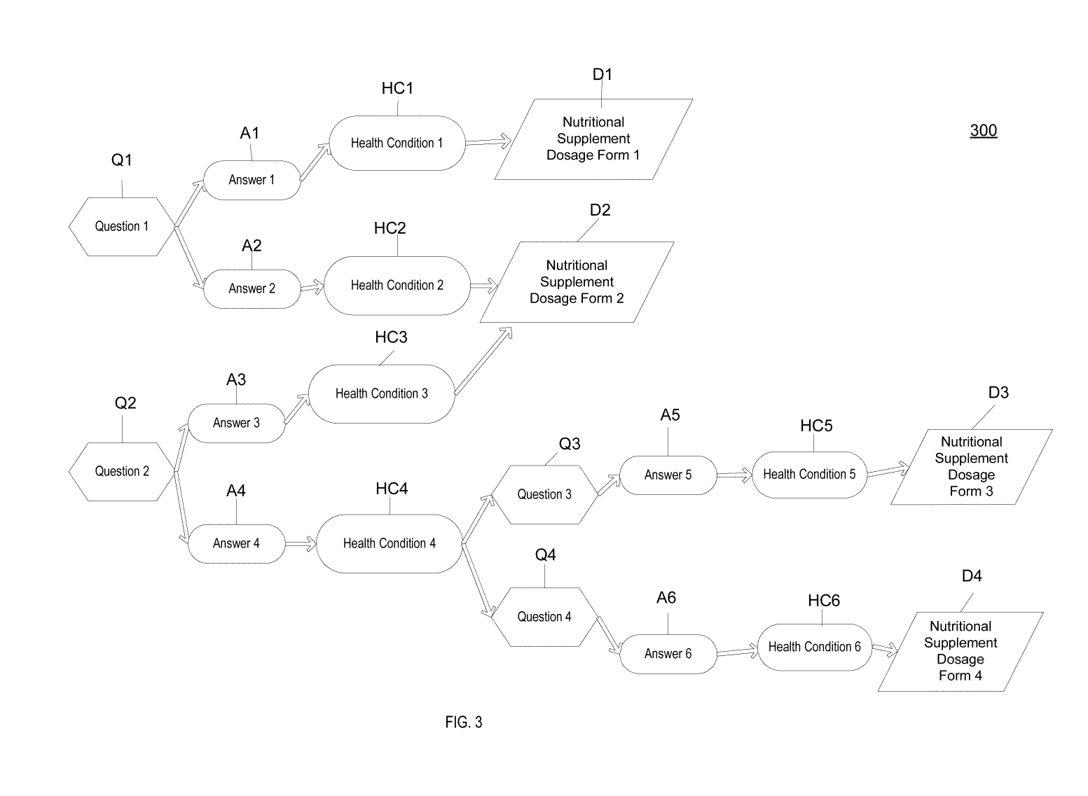

Mapping module 107 may receive the questionnaire from the questionnaire module 106 and link each responsive answer to each associated, responsive component and/or dosage form. By linking each responsive answer to each associated, responsive component and/or dosage form, the mapping module 107 may create a map 108, which represents an algorithm linking each of the questions contained in an exemplary questionnaire to each of the responsive components and/or dosages associated with those questions. An exemplary map 108 is depicted in FIGS. 2 and 3 which are discussed in additional detail below.

In an exemplary embodiment, the map 108 may be prepared, directly or indirectly, by a nutritionist, a dietician, and/or any other health professional based on the knowledge base 105 and the questionnaire. In addition, the map 108 may be prepared, in whole or in part, by a computer program or a computer system based on the questionnaire, optionally with the assistance of a computer programmer.

Identification module 115 may receive the questionnaire from questionnaire module 106, and the map 108, from the mapping module 107, and provide the questionnaire to consumer interaction module 110.

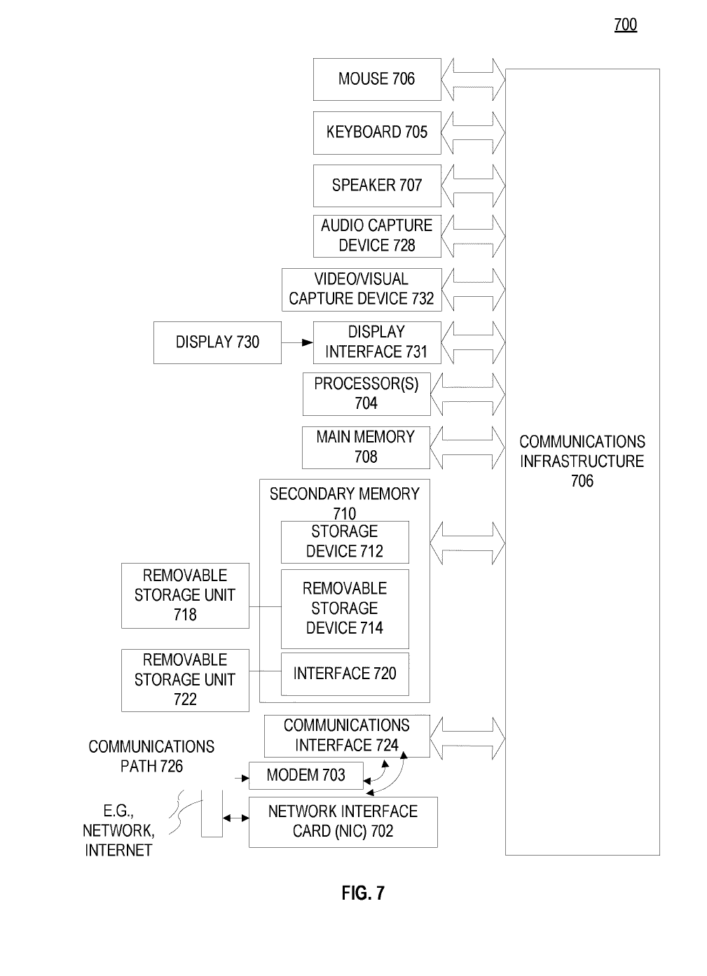

Consumer interaction module 110 may then provide the questionnaire to a user via, for example, a display interface or a speaker. An exemplary display interface may be a combination of a graphical user interface cooperating with an exemplary computer system. An exemplary display interface, an exemplary speaker, and an exemplary computer system are described below in connection with FIG. 7.

Consumer interaction module 110 may then receive the answers to the questionnaire from the user. The consumer interaction module 110 may provide those answers to the identification module 115.

The identification module 115 may receive the answers to the questionnaire from customer interaction module 110 and use those answers to identify the set of responsive component(s) and/or responsive dosage forms(s), which correspond to the answers provided by the user in response to the questionnaire, based on the map 108, which was received from the mapping module 107. In an exemplary embodiment, the responsive components and/or responsive dosage form(s) may be for regular (for example, daily, every other day, every three days, weekly, biweekly, and monthly) or irregular consumption by the user.

The exemplary control module 120 may receive the set of responsive component(s) and/or responsive dosage form(s) and identify a recommended nutritional supplement regimen. The control module 120 may identify an exemplary recommended nutritional supplement regimen by correcting and/or optimizing the set of responsive component(s) and/or responsive dosage form(s) to arrive at a recommended nutritional supplement regimen which contains only dosage forms.

The control module may correct the set of responsive component(s) and/or responsive dosage form(s) by identifying component(s) and/or responsive dosage form(s) that may be dangerous or offensive to the user and correcting the set of responsive component(s) and/or responsive dosage form(s). Component(s) and/or responsive dosage form(s) that may be dangerous or offensive to the user may include, for example, component(s) and/or responsive dosage form(s) to which the user is allergic, component(s) and/or responsive dosage form(s) which negatively interact with a medication taken by the user, and component(s) and/or responsive dosage form(s) which violate the user's dietary restrictions. In addition, component(s) and/or responsive dosage form(s) may be dangerous where the set of responsive component(s) and/or responsive dosage form(s) contain more than the recommended daily allowance of a particular component. Once identified, the control module can reduce the amount of any problematic components and/or identify and add a substitute component to the regimen. Substitute components may be identified in the map as part of the predetermined set of nutrients associated with answers to the various questions.

The control module 120 may optimize the set of responsive component(s) and/or responsive dosage forms(s) by identifying, in cooperation with the packaging module 125 (described below) combination dosage forms. Combination dosage forms may allow the control module 120 to minimize the number of responsive component(s) and/or responsive dosage from(s) in the set of responsive component(s) and/or responsive dosage form(s). For example, the control module 120 may identify a combination dosage form that takes the place of two or more dosages from the recommended set. The control module 120 may also identify the smallest number of combination dosage forms which contain each responsive component(s) from the set of set of responsive component(s) and/or responsive dosage form(s). The control module 120 may also optimize by selecting a set of combination dosage forms which contains all, or substantially all, of the responsive component(s) and/or responsive dosage form(s) from the set of set of responsive component(s) and/or responsive dosage form(s). For example, the control module may be set to limit the number of dosage forms per daily package to 5, 6, 7, 8, 9, 10, 11, 12, or 13 dosage forms (or another lower or higher number, depending on consumer preference, the contents of the dosage forms, and the number of packets being selected,) which together must contain all of the components or dosage forms in the recommended set.

In an exemplary embodiment, the control module 120 may further adjust the set of responsive component(s) and/or responsive dosage forms(s) by substituting alternative dosage form(s) for those responsive dosage form(s) which are out of stock. The control unit 120 may, for example, receive information regarding the availability of a dosage form(s) from the packaging module 125. This information may be shared on a real-time basis, an on demand basis, a periodic basis, or at random intervals.

According to the invention, when the control module 120 receives a set containing one or more responsive component(s), as opposed to dosage forms, the control module 120 may identify responsive dosage forms which contain all, or substantially all, of the responsive components. The control module may, for example, identify responsive dosage forms which are present in the packaging module 125.

Control module 120 may then communicate with the customer interaction module 110 to extend an offer to sell the recommended nutritional supplement regimen, containing one or more daily packets to the user. The control module 120 may also allow the customer to buy less than the full recommended nutritional supplement regimen or more than the recommended nutritional supplement regimen, as is described elsewhere in this specification. If the user accepts, the customer interaction module 110 may obtain payment and shipping information as well as store the user's information for later use.

The control module 120 may then control the nutritional product packaging module 125.

The nutritional product packaging module 125 may receive the recommended nutritional supplement regimen from the control module 120 and package one or more daily packets 130. The nutritional product packaging module may contain, for example, a plurality of available dosage forms. The packaging module 120 may contain an equal or greater number of dosage forms than the number of dosage forms in the recommended nutritional supplement regimen. For example, the nutritional product packaging module 125 may contain 10, 20, 30, or 40 different dosage forms and be capable of dispensing single units of each dosage form into a common daily packet.

In an exemplary embodiment, each daily packet may contain one day's worth of dosage forms which are consistent with the recommended nutritional supplement regimen. Daily packets 130 can be in groups of, for example, two weeks, twenty eight days (four weeks), thirty days (i.e., a month), sixty days (i.e., two months), and/or ninety days (i.e., three months). In addition, daily packets 130 within a group of packets may not, necessarily, contain the same number of pills where, for example, an exemplary dosage should not be taken on a daily basis. Thus, individual daily packets 130 may contain dosages which are to be consumed on, for example, every-other-day, weekly, or monthly basis.

In an exemplary embodiment, the nutritional product packaging module 125 may communicate with the control module 120 to exchange information relating to nutritional dosage forms which are in stock or are out of stock. The control module 120 may utilize this information when identifying the recommended nutritional supplement regimen. For example, when the nutritional packaging module 130 indicates that a nutritional supplement dosage form is out of stock, this information may be communicated to the control module 120. The control module 120 may then delay shipment until the component is restocked, or identify a substitute dosage form to take the place of the nutritional supplement dosage form which is out of stock, and may then update the corrected nutritional supplement dosage form regiment.

Fulfillment module 135 may then ship the daily packets to the user using the shipping information previously obtained.

FIG. 2 depicts an exemplary question-answer-nutritional-supplement map 200 of an exemplary algorithm. FIG. 2 will be described in connection with FIG. 1. In an exemplary embodiment, map 200 may be based on the nutritional knowledge base module 105, the questionnaire module 106, and may be intended to prevent the user from acquiring a health condition and/or to treat the user for a current health condition. Exemplary map 200 may be a “quasi-decision tree” in which the relationship between a question and answer, a health condition, a nutritional supplement, and/or a nutritional supplement dosage form may be mapped. In an exemplary embodiment, map 200 may contain only questions which result in answers, where those answers are linked to a health condition necessitating a nutritional supplement and/or a nutritional supplement dosage form. However, in another exemplary embodiment, certain questions may have answers which are not directly or indirectly linked to a health condition which necessitates a nutritional supplement and/or a nutritional supplement dosage form. For example, if a user's diet contains a sufficient amount of fish, the user does not need additional omega-3 in his diet and will, therefore, not receive more omega-3 in her recommended regimen.

Exemplary map 200 enables the questionnaire to be depicted simply as a series of questions and answers, where each answer is linked to a nutritional supplement and/or nutritional supplement dosage form in a concrete and in a predetermined and complete manner. Exemplary map 200 may be established before a user views the questionnaire. By establishing a question-to-answer to nutritional supplement and/or nutritional supplement dosage form map, i.e. a one-to-one-to-one mapping, the exemplary map 200 improves efficiency by enabling the quick identifications of a customized recommended nutritional supplement regimen for each user. A computer system of the invention, or its operators, may or may not actually use a map like this, but logic such as is depicted in FIG. 2 is implicit in certain methods employing algorithms according to the invention, and the term “map” or “question-answer-nutritional supplement map” is used in both senses as an actual or implicit map.

In an exemplary embodiment, map 200 may depict question Q1 which may be answered in two ways (i.e. answers A1, A2). Once a user selects answer A1 or answer A2, the exemplary map 200 may assist the identification module 115 in identifying the related health condition (HC1 or HC2) previously linked to the answer. After having identified the health condition, which corresponds to the answer provided by the user, the exemplary map 200 may then assist the identification module 115 in identifying the nutritional supplement which addresses the identified health condition and/or the nutritional supplement dosage form which contains the nutritional supplement that corresponds to that health condition. In an alternative embodiment of the exemplary map 200, exemplary map 200 may omit health conditions HC1-HC6 and have answers directly linked to nutritional supplements and/or nutritional supplement dosage forms.

FIG. 3 depicts an exemplary question-answer-nutritional supplement map 300 of an exemplary algorithm. FIG. 3 will be described in connection with FIG. 1. Map 300 may be similar to map 200, however, map 300 directly links a health condition to a nutritional supplement dosage form, rather than linking a health condition to a nutritional supplement, as in exemplary map 200. Similar to exemplary map 200, an alternative embodiment of exemplary algorithm 300 may not include a health condition linked to the answer. Rather, an answer may be directly linked to the nutritional supplement dosage form which addresses the corresponding health condition. The dosage form may contain one or more components.

Exemplary maps or algorithms 200 and/or 300 may be used by the control module 120 to interpret the answers to the questionnaire provided to the user by consumer interaction module 110. For example, exemplary algorithms 200 or 300 may identify the nutritional supplement or supplements and/or the nutritional supplement dosage forms which may serve as the basis for a recommended nutritional supplement dosage form regiment.

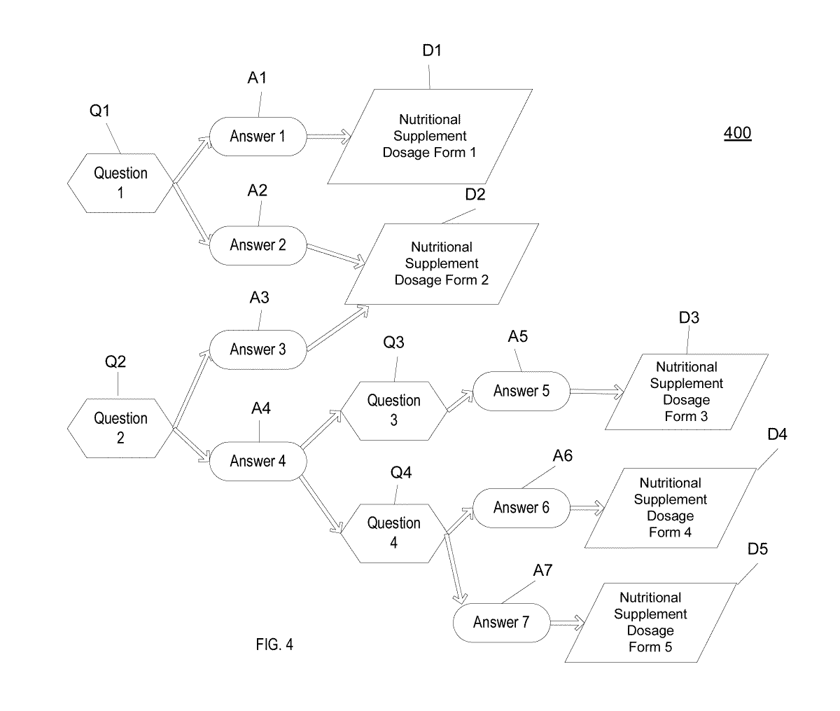

FIG. 4 depicts an exemplary question-answer-nutritional supplement map 400 of an exemplary algorithm. FIG. 4 represents a map 400 which resembles FIGS. 2 and 3 but omits the health conditions.

In an exemplary embodiment, exemplary map 400 may aid in the identification of a conflict with a user dietary restriction and the resolution of the conflict. Map 400 may, for example, be based on an exemplary algorithm that identifies one or more substitute dosages for at least one dietary restriction the user may possess. For example, question Q4 may ask whether the user has a specific or general dietary restriction. If the user indicates that he/she does not possess a specific dietary restriction, the map 400 may continue to answer A6 and onto dosage D4. If, however, the user indicates that he/she possess a specific dietary restriction, the map 400 may continue to answer A7 and onto dosage D5. Dosage D5 may be a substitute dosage for dosage D4.

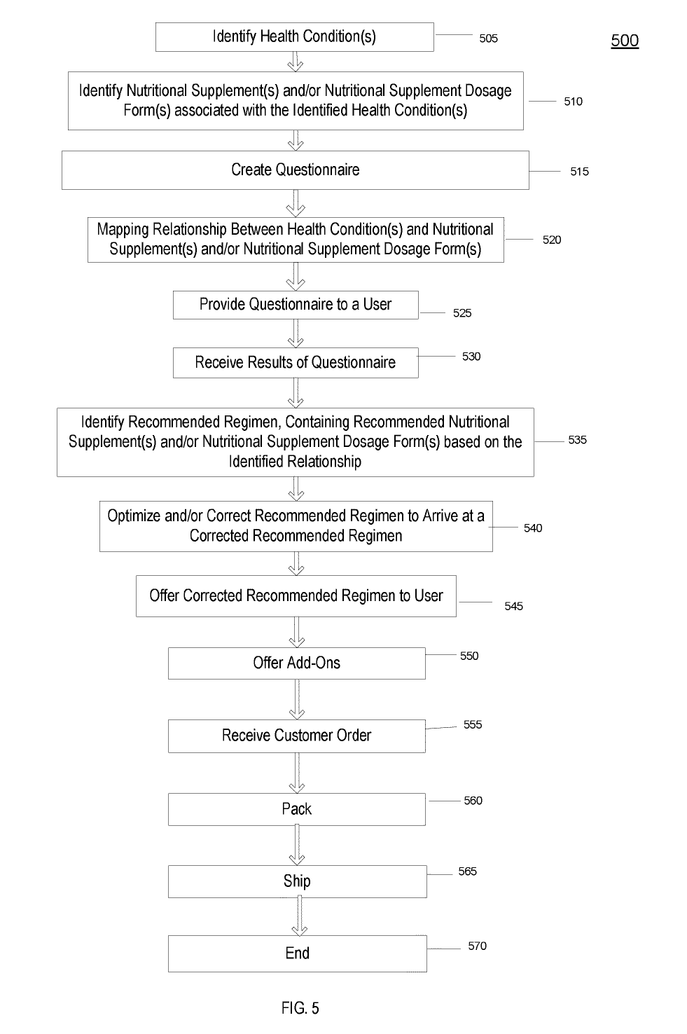

FIG. 5 depicts an exemplary flowchart for an exemplary method for providing a personalized, daily nutritional supplement package. Process 500 will be described in connection with FIG. 1, FIG. 2, and FIG. 3. Process 500 may begin with Block 505.

In Block 505, one or more health conditions may be identified by the questionnaire module 106 from a plurality of health conditions contained in the nutritional knowledge base module 105. The nutritional knowledge base may contain, for example, statistics or information regarding a plurality of health conditions possessed by various percentages of a population as well as common nutritional deficiencies, warning signs of nutritional deficiencies, etc. The knowledge base 105 may also contain information on risk factors for acquiring one or more of the health conditions and/or ways in which a user may avoid acquiring one or more of the health conditions. In an exemplary embodiment, a subset of the plurality of health conditions contained in the knowledge base 105 may be selected, in block 105, to be included in the questionnaire. Additionally, block 505 may identify a manageable number of health conditions to address, rather than a large number of health conditions. For example, in FIGS. 2 and 3, exemplary maps 200 and 300 may include only four health conditions HC1-HC6. Or there may be 5, 6, 7, 10, 12, or more health conditions involved. Health conditions HC1-HC6 may represent health conditions commonly or uncommonly, possessed by the average users. From block 505, process 500 may continue to block 510.

In Block 510, the nutritional supplements and/or nutritional supplement dosage forms associated with the identified health conditions may be identified by the questionnaire module 106. Nutritional supplements and/or nutritional supplement dosage forms associated with the identified health conditions may include, for example, but are not limited to, those supplements and/or dosage forms which address, cure, remediate and/or mask one or more of the identified health conditions. In an exemplary embodiment, Block 510 may be performed by the nutritional knowledge base module 105, or may be contained in the nutritional knowledge base module 105. For example, in FIGS. 2 and 3, nutritional supplements NS1-NS5 and/or nutritional supplement dosage forms D1-D4 may be identified by the nutritional knowledge base module 105. These nutritional supplements and nutritional supplement dosage forms may be associated with one or more of health conditions HC1-HC6. From block 510, process 500 may continue to block 515.

In Block 515 a questionnaire may be created based on the health conditions and related nutritional supplements selected by the questionnaire module 106 in blocks 505 and 510. An exemplary questionnaire may comprise a series of questions and answers, each question being associated with at least two responsive answers. An exemplary questionnaire is depicted in Appendix 1. In an exemplary embodiment, the questionnaire is created by the questionnaire module 106. For example, in FIGS. 2 and 3, questions Q1-Q4 may be associated with answers A1-A6. From block 515, process 500 may continue to block 520.

In block 520, the relationship between questions and answers in the questionnaire as well as the identified health conditions and the nutritional supplements and/or nutritional supplement dosage forms may be mapped. An exemplary mapping may include a one-to-one-to-one linkage, between a question, wherein the question relates to a health condition, an answer, where the answer also relates to the question, and a nutritional supplement and/or nutritional supplement dosage form, where the supplement or dosage form addresses the health condition. Continuing with the example above, an exemplary map may be similar to exemplary map 200 and/or exemplary map 300 of FIGS. 2, 3, and 4 wherein the relationship between questions Q1-Q4, answers A1-A6, health conditions HC1-HC6, and nutritional supplements NS1-NS5 and/or nutritional dosage forms D1-D4 may be mapped. From block 520, process 500 may continue to block 525.

In block 525, the questionnaire is provided to a user. In an exemplary embodiment, a questionnaire may be provided to the user by custom interaction module 110. From block 525, process 500 may continue to block 530.

In block 530, the results from the questionnaire may be received. In an exemplary embodiment, the results to the questionnaire may be received by the custom interaction module 110 and sent to identification module 115. From block 530, process 500 may continue to block 535.

In block, 535, a set of responsive component(s) and/or responsive dosage form(s) may be identified, based on the mapping, by identification module 115. From block 535, process 500 may continue to block 540.

In block 540, a recommended regimen may be identified by correcting and/or adjusting the set of responsive component(s) and/or responsive dosage form(s). In an exemplary embodiment, the recommended regimen may be reduced and/or corrected to adjust for the maximum daily allowable limits of certain vitamins and minerals, user allergies, user dietary preferences, or duplicate nutritional supplements and or nutritional supplement dosage forms. Examples of user dietary preferences are, for example, user likes and dislikes of certain supplements and or dosage forms such as fish oil, a user's wish to avoid animal products and/or to obtain organic products. In an exemplary embodiment, the daily package may contain a minimum of 1-3 pills and a maximum of 6, 8, 10, or 12 pills. From block 540, process 500 may continue to block 545.

In block 545, the corrected recommended regimen may be provided to a user. In an exemplary embodiment, the corrected recommended regimen may be provided to the user in the form of an offer for sale of a plurality of daily packages containing one day's supply of the corrected recommended regimen. The user may then opt to accept the offer for sale or decline the offer for sale. Additionally, the user may be allowed to purchase less than all of the dosage forms in the recommended nutritional supplement regimen. An exemplary packaging of the daily package is described in connection with FIG. 600. From block 545, process 500 may continue to block 550.

In block 550, the user may be presented with an offer for sale of additional add-on products. In an exemplary embodiment, an add-on product may be a group of one or more nutrition supplements or dosage forms which improve a general health conditions of a user. Exemplary general health conditions may include heart health, eye sight, brain function, muscle mass, etc. . . . These add-on products may be offered to a user regardless of the user's response to the questionnaire. From block 550, process 500 may continue to block 555.

In block 555, a customer order may be received by control module 120. From block 555, process 500 may continue to block 560.

In block 560, the corrected recommended regimen may be assembled by packaging module 130. From block 560, process 500 may continue to block 565.

In block 565, the regimen may be shipped to the user. From block 565, process 500 may continue to block 570.

In block 570, the process may end.

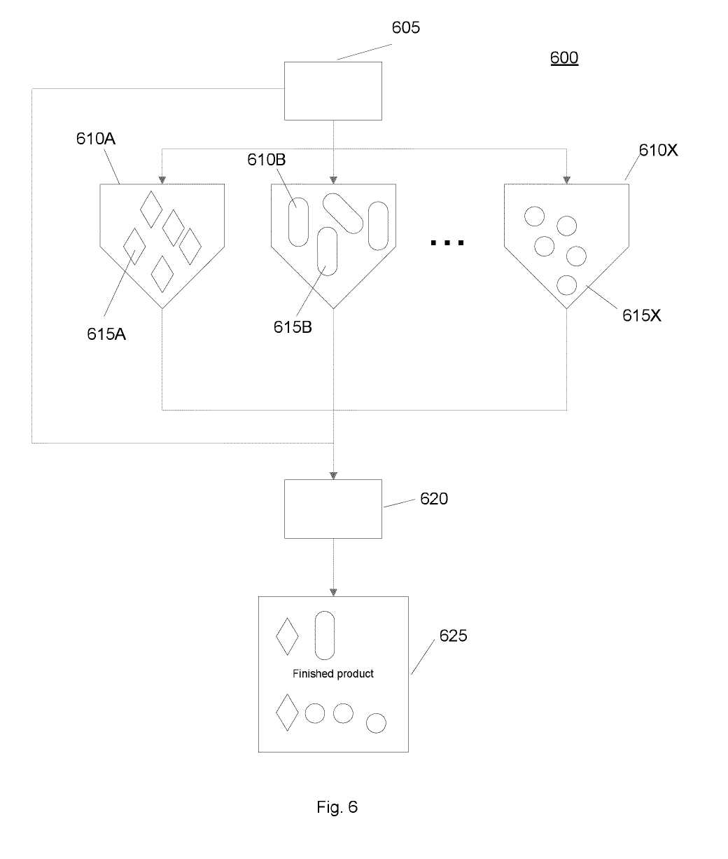

FIG. 6 depicts an exemplary system 600 for assembling a personalized, daily nutritional supplement package. System 600 contains, for example, control apparatus 605. An exemplary control apparatus 605 is described in connection with block 110 in FIG. 1. Exemplary control apparatus 605 may be connected/coupled to, for example, but not limited to, hoppers 610A-610X and assembly apparatus 620.

System 600 may also contain a plurality of hoppers wherein each of the plurality of hoppers may contain a different dosage form. System 600 includes only three exemplary hoppers 610A-610X, for ease of illustration. In system 600, hopper 610A contains dosage form 615A, hopper 610B contains dosage form 615B and hopper 610X contains dosage form 615X. In an exemplary embodiment, hopper 610A-610X may be designed to only allow a specific supplement to be dispensed. For example, hoppers 610A may be able to detect the presence of dosage forms 615B or 615X by detecting a dosage form's size, weight, color, etc. prior to dispensing the dosage form. If hopper 610A detects a supplement other than supplement 615A, hopper 610A may not dispense the incorrect supplement.

System 600 may also contain assembly apparatus 620. Assembly apparatus 620 may contain the mechanical apparatus needed to place individual dosage forms into a daily package. For example, assembly apparatus 620 may contain conveyor belts, control nozzles and the like. In an exemplar embodiment, assembly apparatus 620 may be common to hoppers 610A-610X or may be coupled to each of hoppers 610A-610X. In an exemplary embodiment, assembly apparatus 620 may be designed to only allow specific supplements to be placed into a daily package. For example, assembly apparatus 620 may be able to detect the presence of an incorrect dosage form by detecting the dosage form's size, weight, color, etc. prior to processing the dosage form. If assembly apparatus 620 detects an incorrect supplement (i.e. a supplement that isn't supposed to be placed inside the daily package) assembly apparatus 620 may prevent the incorrect supplement from being included into the daily package.

System 600 may conclude with the assembly of a daily nutritional supplement package 625 or a set of daily nutritional supplement packages 625. For example, finished daily nutritional supplement package 625 in FIG. 6 may contain two of dosage forms 615A, one of dosage forms 615B and three of dosage forms 615X.

FIG. 7 depicts an exemplary computer system 700 such as may be used in, or in combination with modules 105, 106, 107, 108, 110, 115, 120, 125, 130, and 135, etc. and that may be used in implementing an exemplary embodiment of the present invention. Specifically, FIG. 7 depicts a computer system 700 that may be used in computing devices such as a client and/or a server, etc., according to an exemplary embodiment of the present invention. The present invention (or any part(s) or function(s) thereof) may be implemented using hardware, software, firmware, and/or a combination thereof and may be implemented in one or more computer systems 700 or other processing systems. The invention may be directed toward one or more computer systems capable of carrying out the functionality described herein. Specifically, FIG. 7 illustrates an example computer 700, which may be a personal computer (PC) system running an operating system such as MICROSOFT® WINDOWS® NT/98/2000/XP/CE/ME/VISTA/etc. or an Apple computer executing MAC OS. However, the invention is not limited to these platforms. Instead, the invention may be implemented on any appropriate computer system running any appropriate operating system. Other exemplary computer systems may include additional components, such as, e.g., a computing device, a communications device, mobile phone, a telephony device, an iPhone (available from Apple of Cupertine, Calif. USA), a 3G wireless device, a wireless device, a telephone, a personal digital assistant (PDA), a personal computer (PC), a handheld device, a portable device, an interactive television device (iTV), a digital video recorder (DVD), client workstations, thin clients, thick clients, fat clients, proxy servers, network communication servers, remote access devices, client computers, server computers, peer-to-peer devices, routers, gateways, web servers, data, media, audio, video, telephony or streaming technology servers, game consoles, content delivery systems, etc. In an exemplary embodiment, services may be provided on demand using, e.g., an interactive television device (iTV), a video on demand system (VOD), via a digital video recorder (DVR), and/or other on demand viewing system.

The computer system 700 may include one or more processors, such as, e.g., processor(s) 704. The processor(s) 704 may be coupled to and/or connected to a communication infrastructure 706 (e.g., a communications bus, cross-over bar, or network, etc.). Various exemplary embodiments may be described in terms of this exemplary computer system 700. After reading this description, it may become apparent to a person skilled in the relevant art(s) how to implement the invention using other computer systems and/or architectures.

Computer system 700 may include a display interface 731 that may forward, e.g., graphics, text, and other data, etc., from the communication infrastructure 706 (or from a frame buffer, etc., not shown) for display on the display unit 730. The display until 730 may be, for example, a television, a computer monitor, and a mobile phone screen. Or the output may be provided as sound through a speaker.

The computer system 700 may also include, e.g., but may not be limited to, a main memory 708, random access memory (RAM), and a secondary memory 710, etc. The secondary memory 710 may include a computer readable medium such as, for example, a hard disk drive 712 and/or a removable storage drive 714, representing a floppy diskette drive, a magnetic tape drive, an optical disk drive, magneto-optical, a compact disk drive CD-ROM, etc. The removable storage drive 714 may, e.g., read from and/or write to a removable storage unit 718 in a well known manner. Removable storage unit 718, also called a program storage device or a computer program product, may represent, e.g., a floppy disk, magnetic tape, optical disk, compact disk, etc. which may be read from and written to by removable storage drive 714. As may be appreciated, the removable storage unit 718 may include a computer usable storage medium having stored therein computer software and/or data. In some embodiments, a “machine-accessible medium” may refer to any storage device used for storing data accessible by a computer. Examples of a machine-accessible medium may include, e.g.: a magnetic hard disk; a floppy disk; an optical disk, like a compact disk read-only memory (CD-ROM), flash memory, non-volatile memory, or a digital versatile disk (DVD); digital video recorder disk (DVR); a magnetic tape; and a memory chip, etc.

In alternative exemplary embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as, e.g., those found in video game devices), a removable memory chip (such as, e.g., an erasable programmable read only memory (EPROM), or programmable read only memory (PROM) and associated socket, and other removable storage units 722 and interfaces 720, which may allow software and data to be transferred from the removable storage unit 722 to computer system 700.

Computer 700 may also include an input device such as, e.g., a mouse 706 or other pointing device such as a digitizer, an audio capture device 728 (such as, e.g., a microphone), an image video/visual capture device 732 (such as, e.g., a camera), and a keyboard 705 and/or other data entry device (not shown), etc.

Computer 700 may also include output devices, such as, e.g., display 730, display interface 731, and/or a speaker 707, etc. Other output devices may also be used, including, e.g., a printer, etc. Computer 700 may include input/output (I/O) devices such as, e.g., communications interface 724 and communications path 726, etc. These devices may include, e.g., network interface card 702, and modem(s) 703. Communications interface 724 may allow software and data to be transferred between computer system 700 and external devices.

In this document, the terms “computer program medium” and “computer readable medium” may be used to generally refer to media such as, e.g., removable storage drive 714, a hard disk installed in hard disk drive 712, a storage area network (SAN), database, etc. These computer program products may provide software to computer system 700. The invention may be directed to such computer program products. In some cases, a computer program product may include software which may be distributed via a communication system and then may be stored on a storage device.

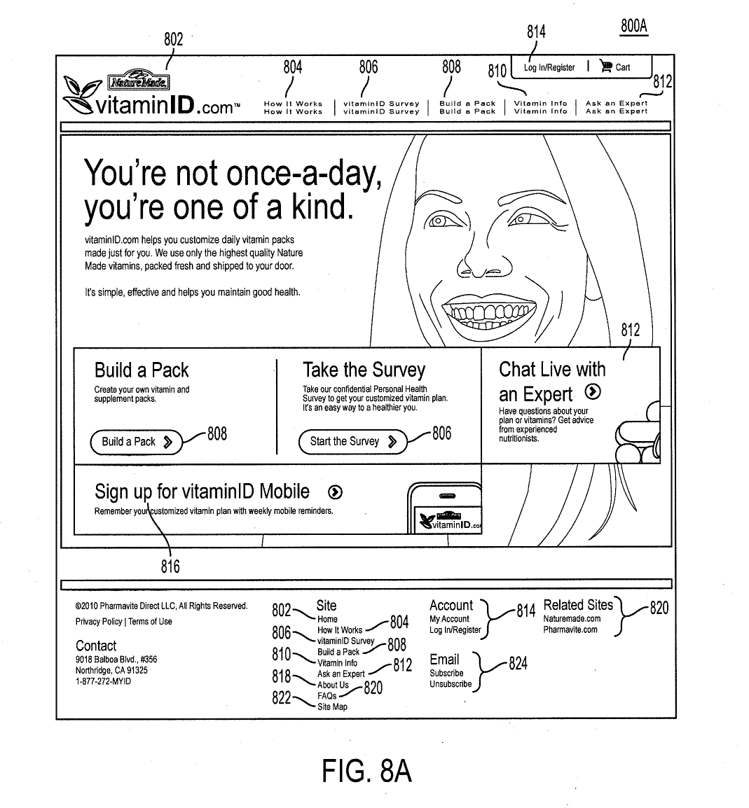

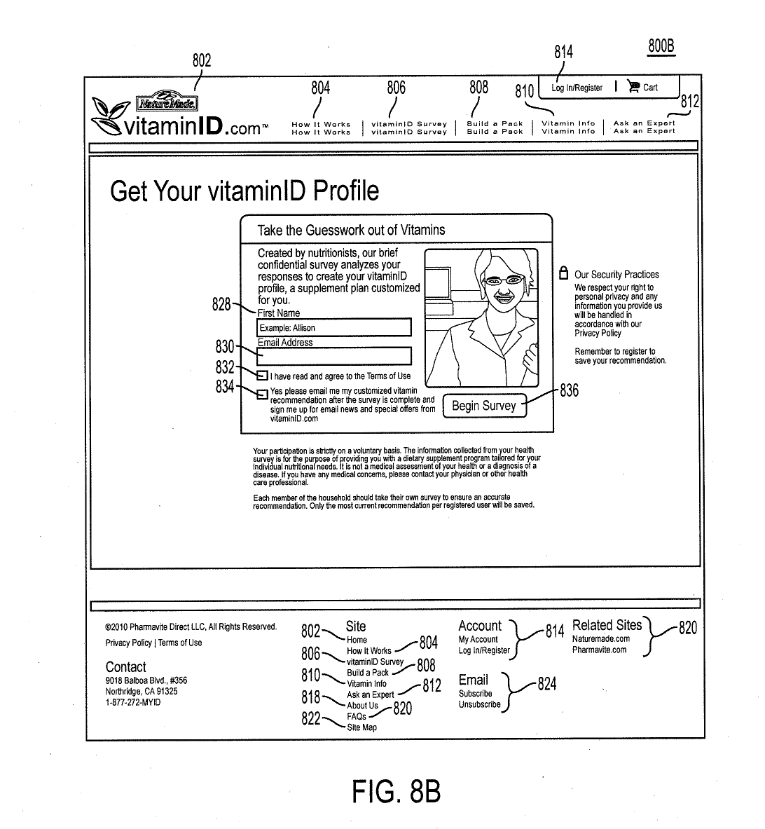

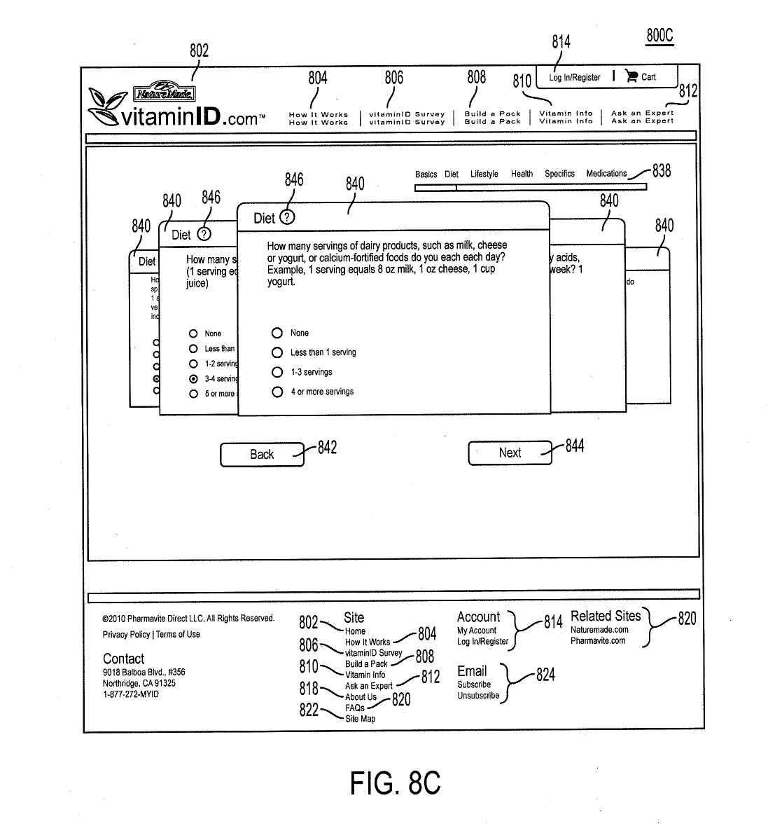

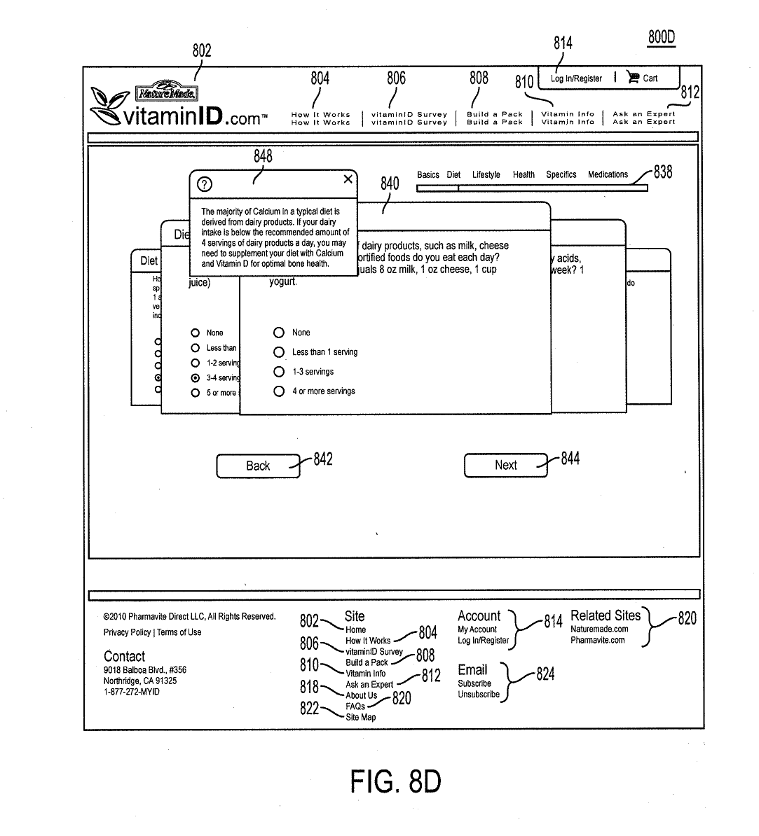

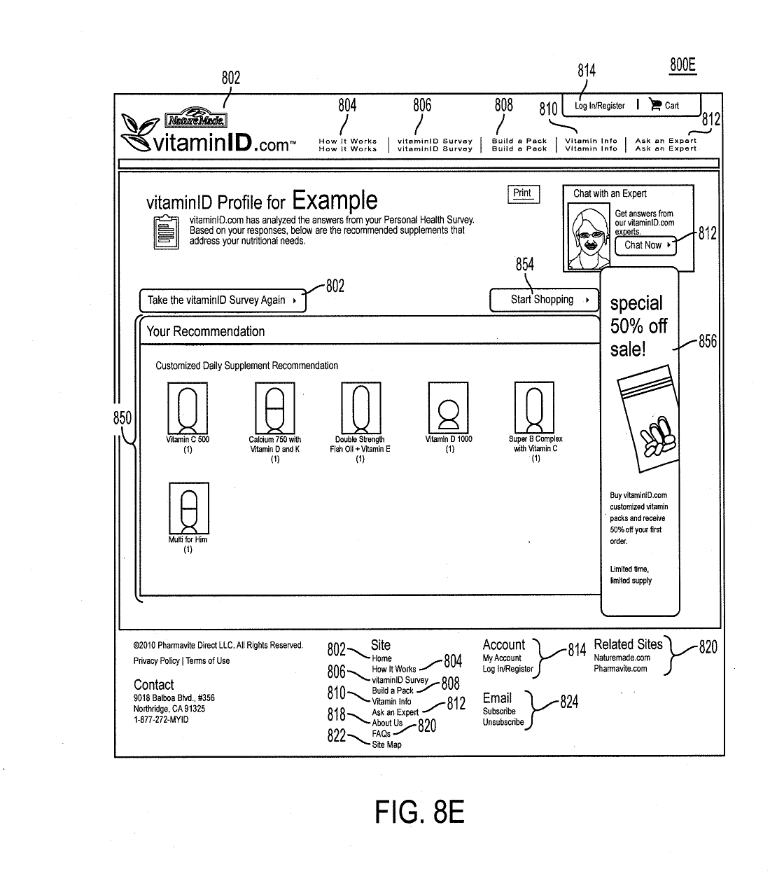

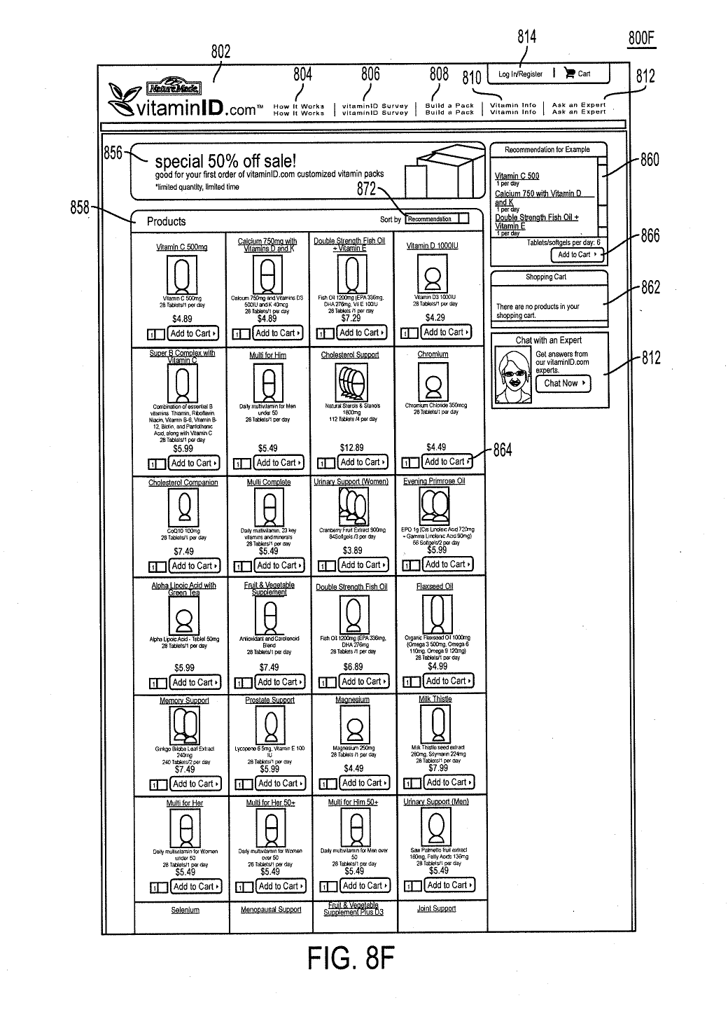

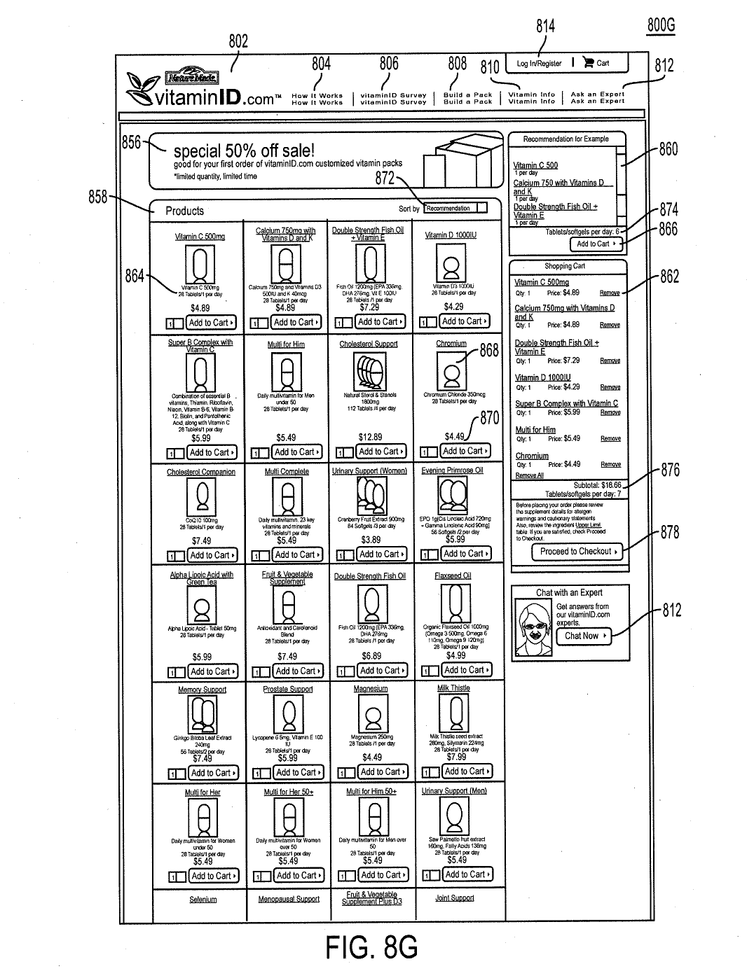

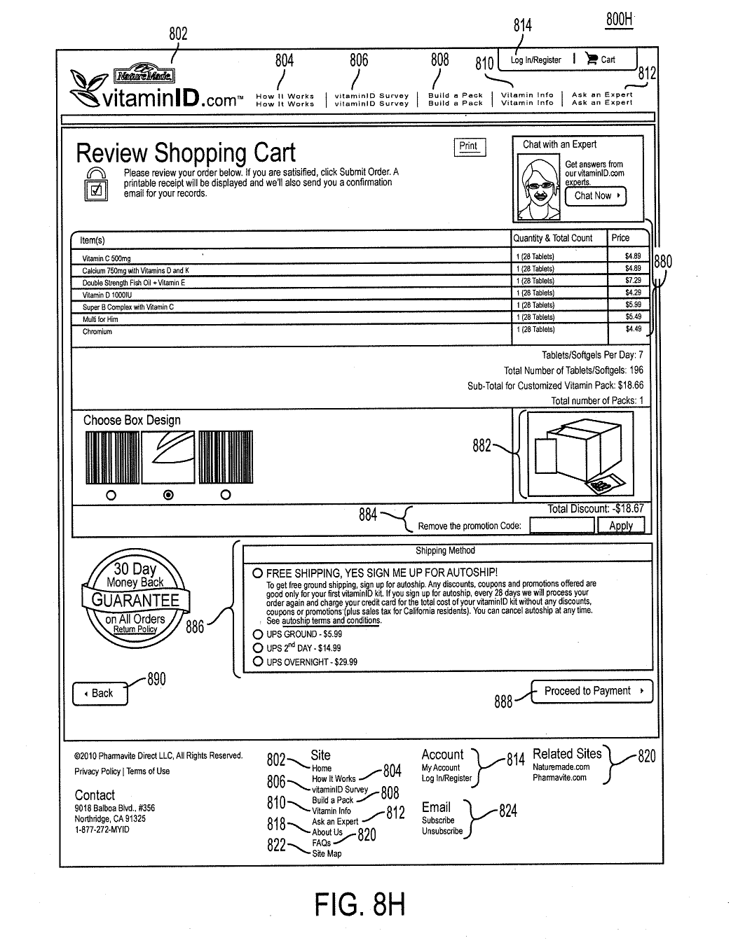

FIGS. 8A-8G depict an exemplary website which incorporates various embodiments of the invention as discussed above.

FIG. 8A depicts an exemplary home page 800A for a company that provides daily nutritional supplement packages. On the home page 800A, a user may reload the company's home page by selecting one of icons 802, access information about the company's services by selecting one of icons 804, take a survey/questionnaire by selecting one of icons 806, begin building a base pack of vitamins by selecting one of icons 808, access information on available nutritional supplement dosage form (such as vitamins) by selecting one of icons 810, chat with an expert by selecting one of icons 812, log into their account by selecting one of icons 814, sign up for mobile reminders by selecting icon 816, access information about the company by selecting icon 818, access frequently asked questions by selecting icon 820, view a site map by selecting icon 822, sign up for an email list serve by selecting icon 824, or view related websites by selecting icon 826.

In FIG. 8B, once a user has selected one of icons 806 in order to take a questionnaire, the user may be presented with page 800B. In page 800B, the user may be asked to enter their first name 828 and their email address 830. The user may also be asked to indicate whether they agree to the company's terms of use 832 and whether they would like to be contacted vie email with the results of the questionnaire and be added to the company's email list 834. The user may be required to, at a minimum, enter their name 828 and agree to the company's terms of use 832 in order to select icon 836 and take the questionnaire. The user may also be required to supply a valid email address in order to take the questionnaire.

In FIG. 8C, once a user has completed page 800B and selected icon 836, the user may be presented with the questionnaire via a series of pages resembling page 800C. In page 800C, the user is presented a questions from an exemplary questionnaire in a windows 840. Once a user has responded to a question in a window 840, the user may select icon 842 to go back and review their answer to a previous question or select icon 844 to proceed to the next question. A user may also select icon 846 in order to receive a brief explanation of a particular question in window 848 in FIG. 8D. In addition, status bar 838 may visually represent how much of the questionnaire the user has completed and how much of the questionnaire the user has left to complete to the user.

In FIG. 8E, once the user has completed the questionnaire, a recommended daily regimen may be presented to the user in exemplary page 800E. In exemplary page 800E a recommended daily regimen, comprised of one or more nutritional supplement dosage forms, may be displayed 850. The recommended daily regimen may be identified based on the user's responses to the questionnaire. On page 800E, the user may also be able to select icon 852 to retake the questionnaire or select icon 854 to begin shopping. Page 800E may also include one or more areas 856 where advertisements may be displayed.

Once a user has selected icon 854 in page 800E, depicted in FIG. 8E, the user may be taken to page 800F, depicted in FIG. 8F. In FIG. 8F, a user may be presented with a list of all the available nutritional products 858, the user's recommended daily regimen, comprised of one or more nutritional products, 860, and the user's shopping cart 862. The list of available nutritional products 858 may be sorted, via dropdown menu 872, by price (low to high or high to low), name, and/or by recommendation (e.g., listing those products which were recommended to the user as part of the user's recommended daily regime first followed by those products which were not). Both the list of available nutritional products 858 and the user's recommended daily regimen may include the price for a multi-day supply (e.g., 28 days). A user may add individual nutritional products 858 into the user's shopping cart 862 by selecting icons 864 or add all of the nutritional products which comprise the user's exemplary recommended daily regimen 860 into the shopping cart 862 by selecting icon 866.

In FIG. 8G, page 800G contains an exemplary shopping cart 862 containing each nutritional supplement in the user's exemplary recommended daily regimen 860, added to the shopping cart 862 after the user selected icon 866, and one additional product 868, added to the shopping cart 862 after the user selected icon 870. Additionally, page 800G may display how many pills, per day, are part of the user's exemplary recommended daily regimen 874 and how many pills, per day, are part nutritional supplements contained in the user's shopping cart 876. Once a user is ready to checkout, the user may select icon 878.

In FIG. 8H, page 800H is displayed in response to the user's selection of icon 878. In page 800H, a user may review their shopping cart 880, select a box design 882, enter a promotional code 884, and select a shipping option 886. Once all of the above have been entered, the user may select icon 888 and enter their payment information or go back to page 800G.

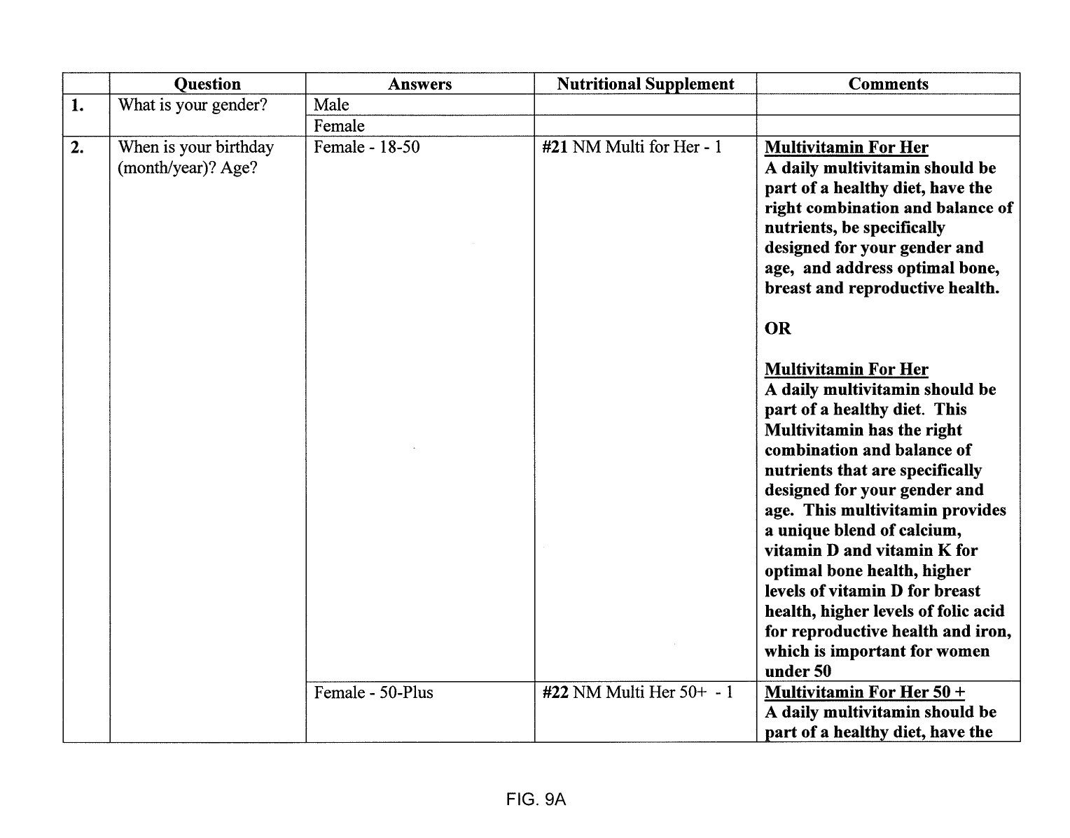

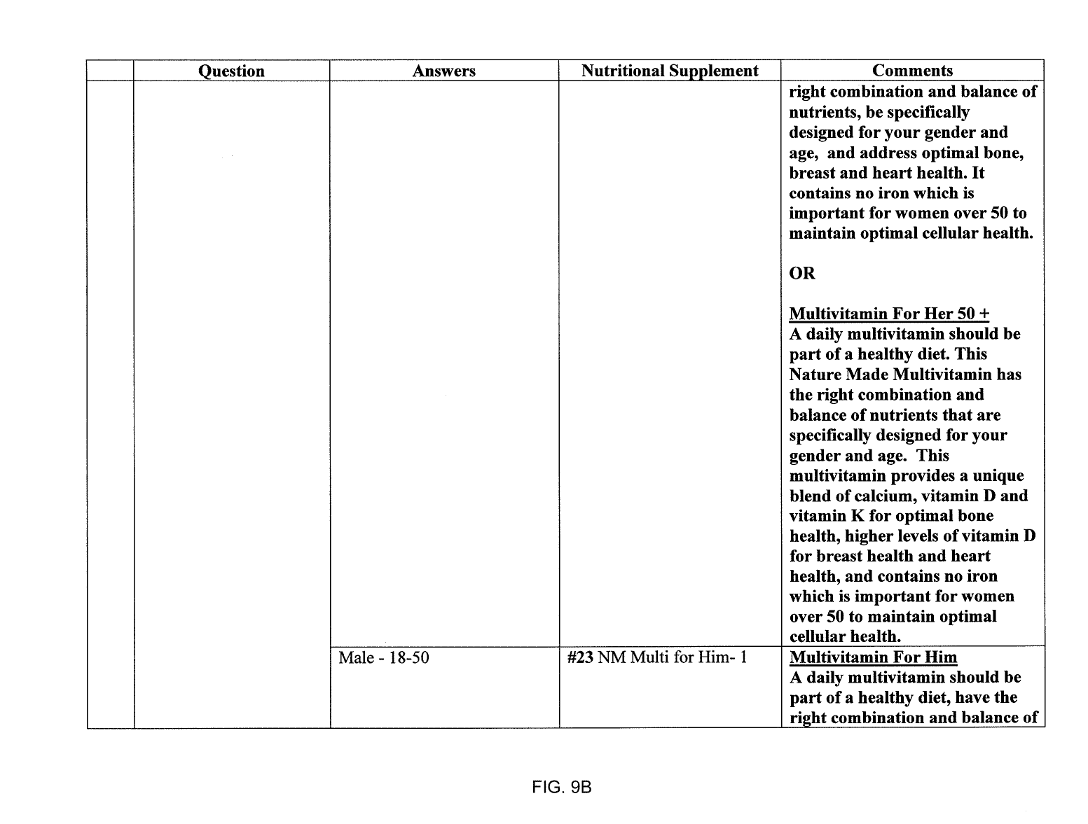

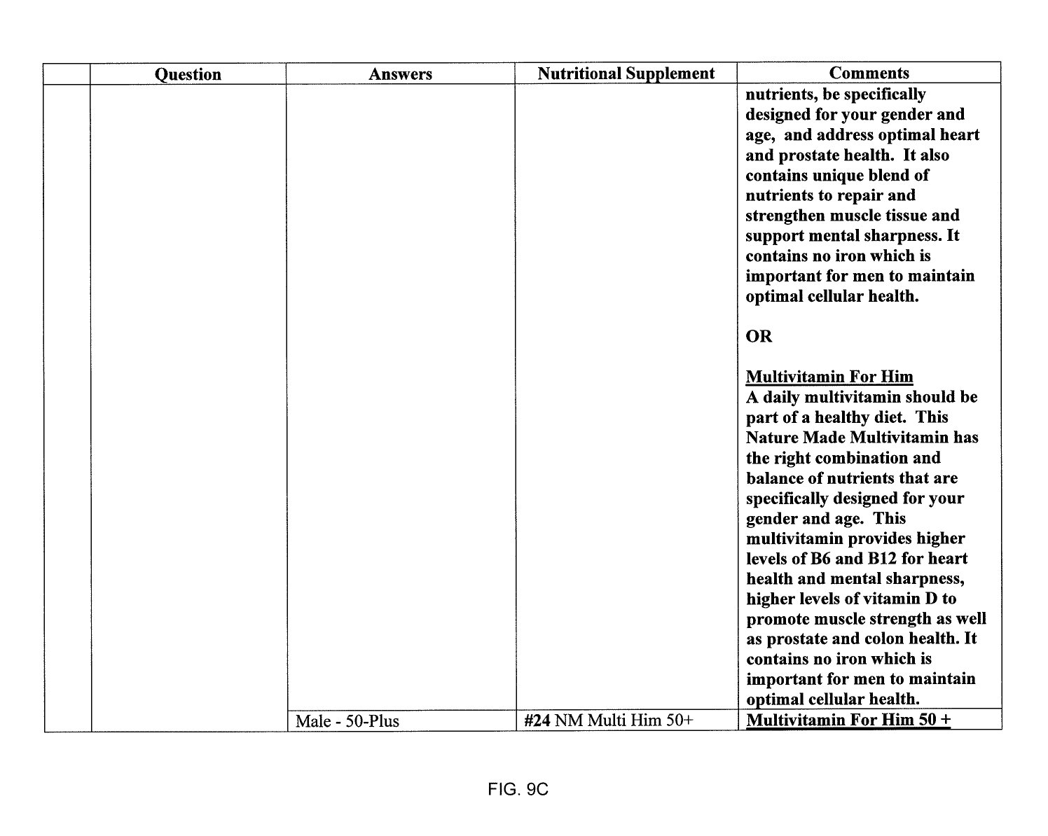

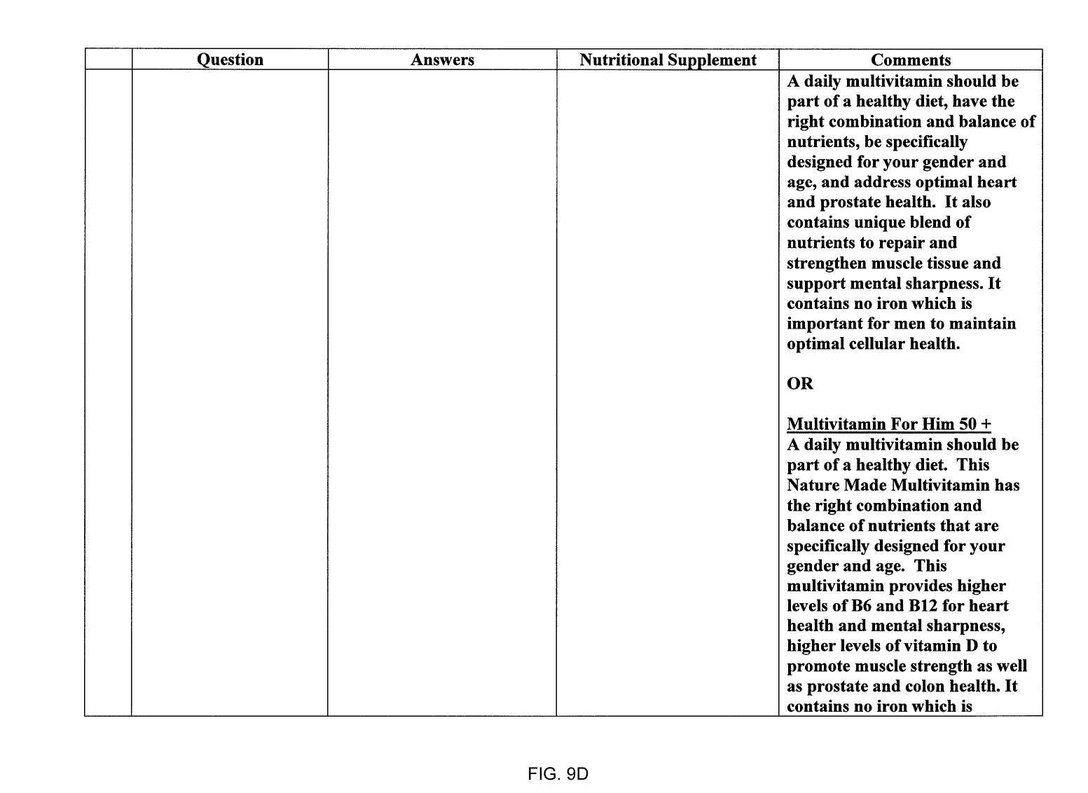

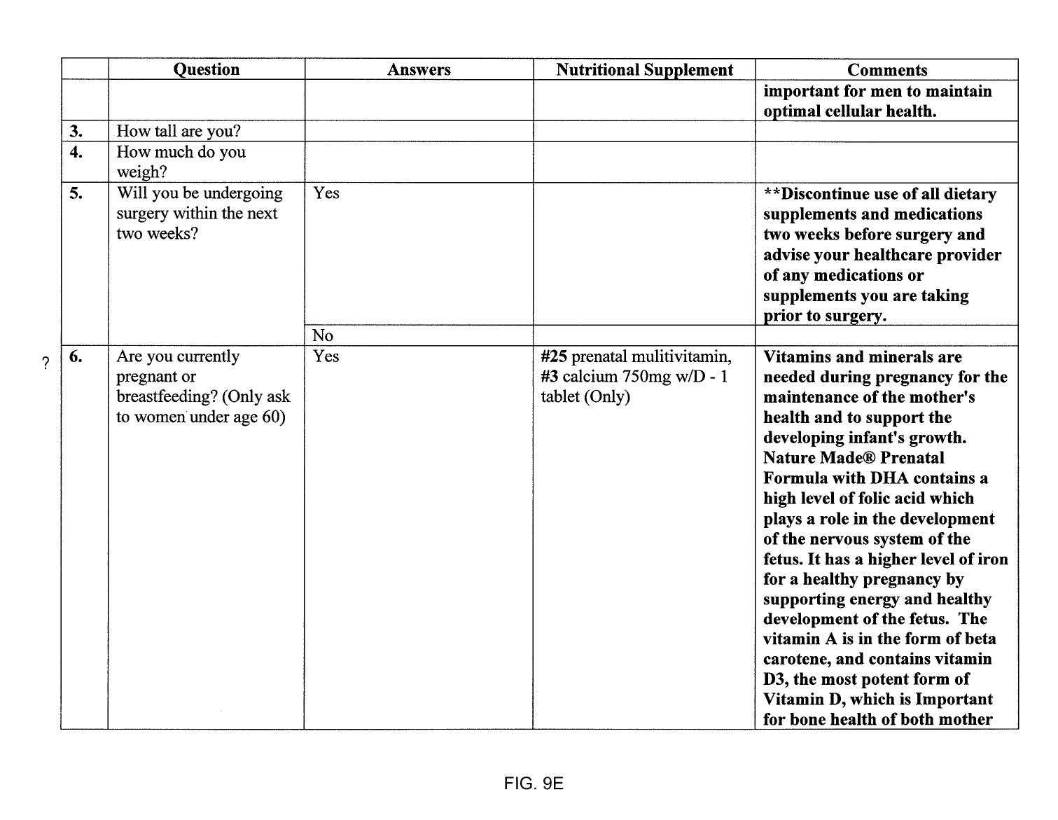

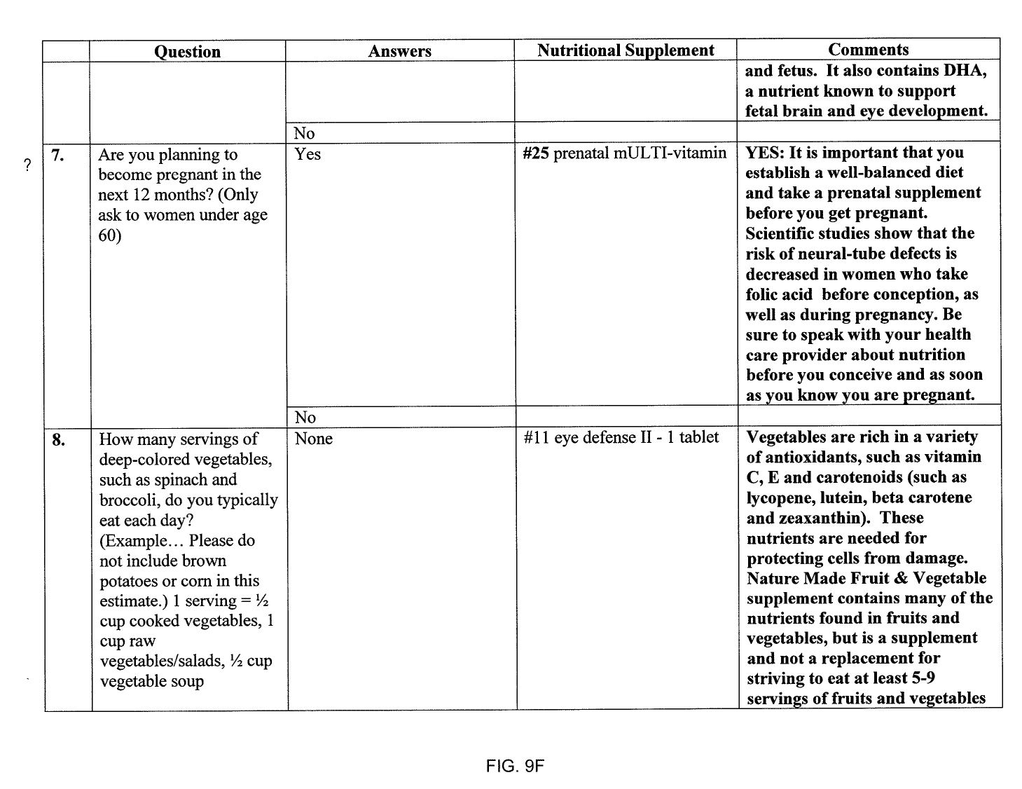

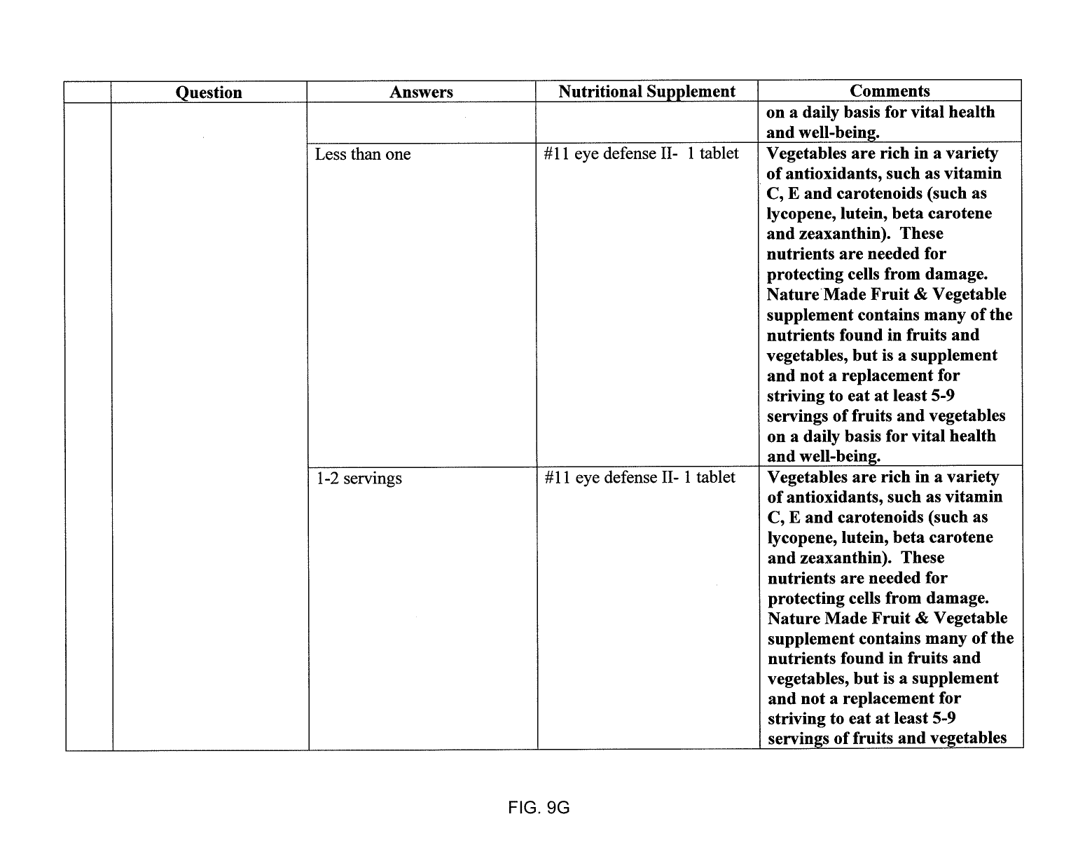

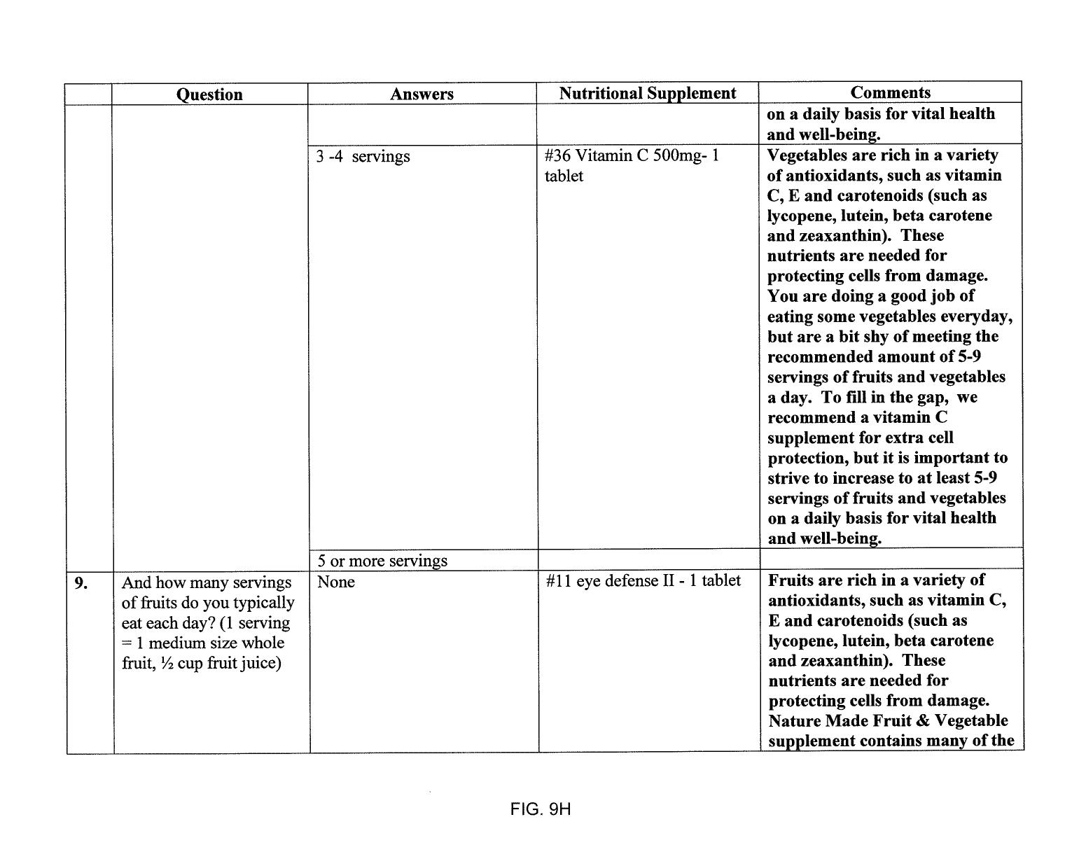

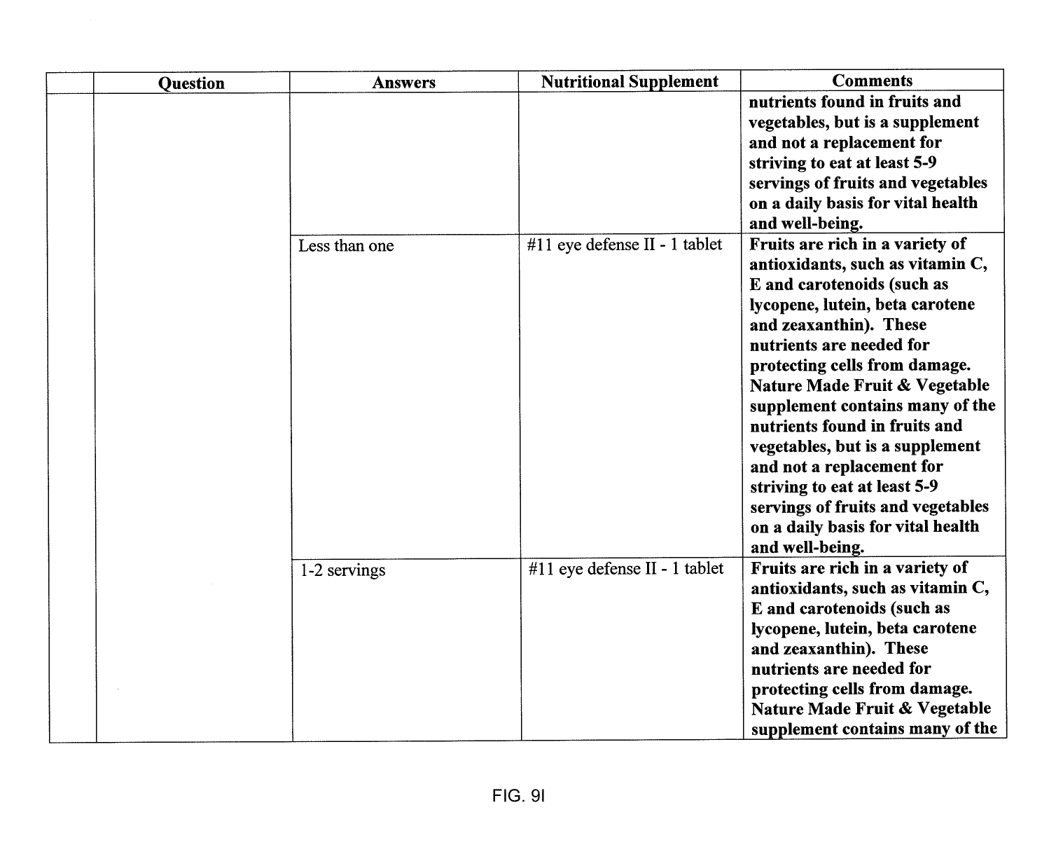

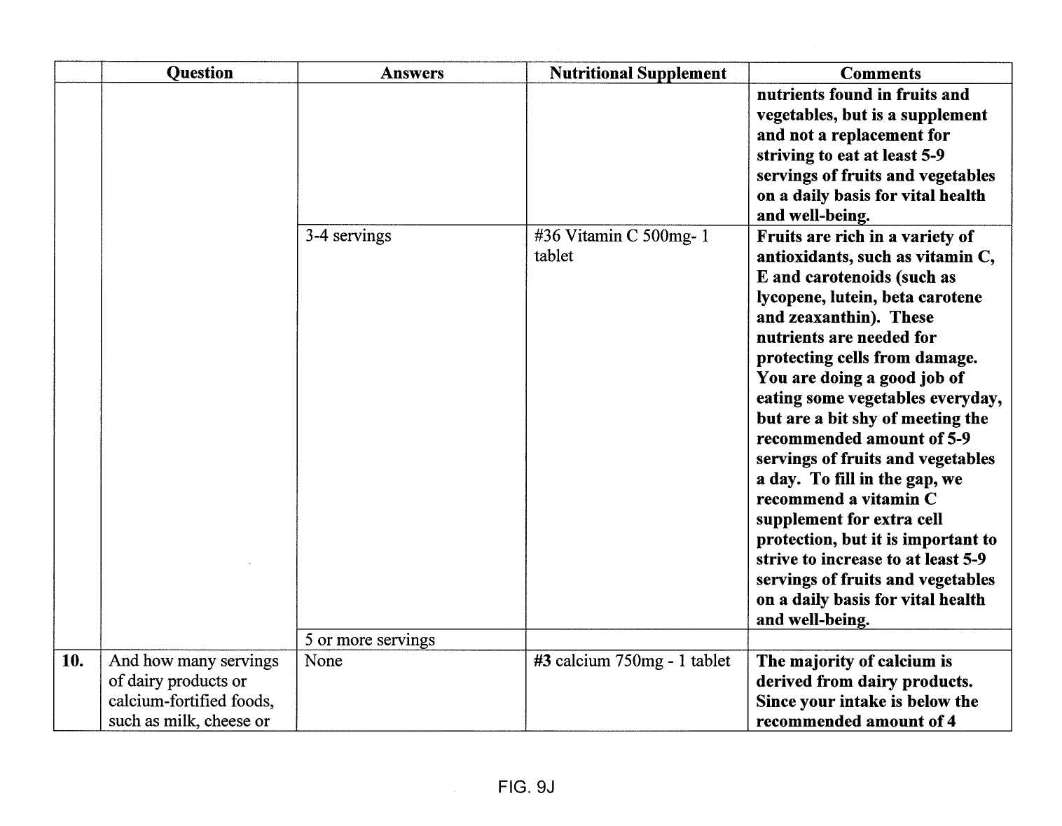

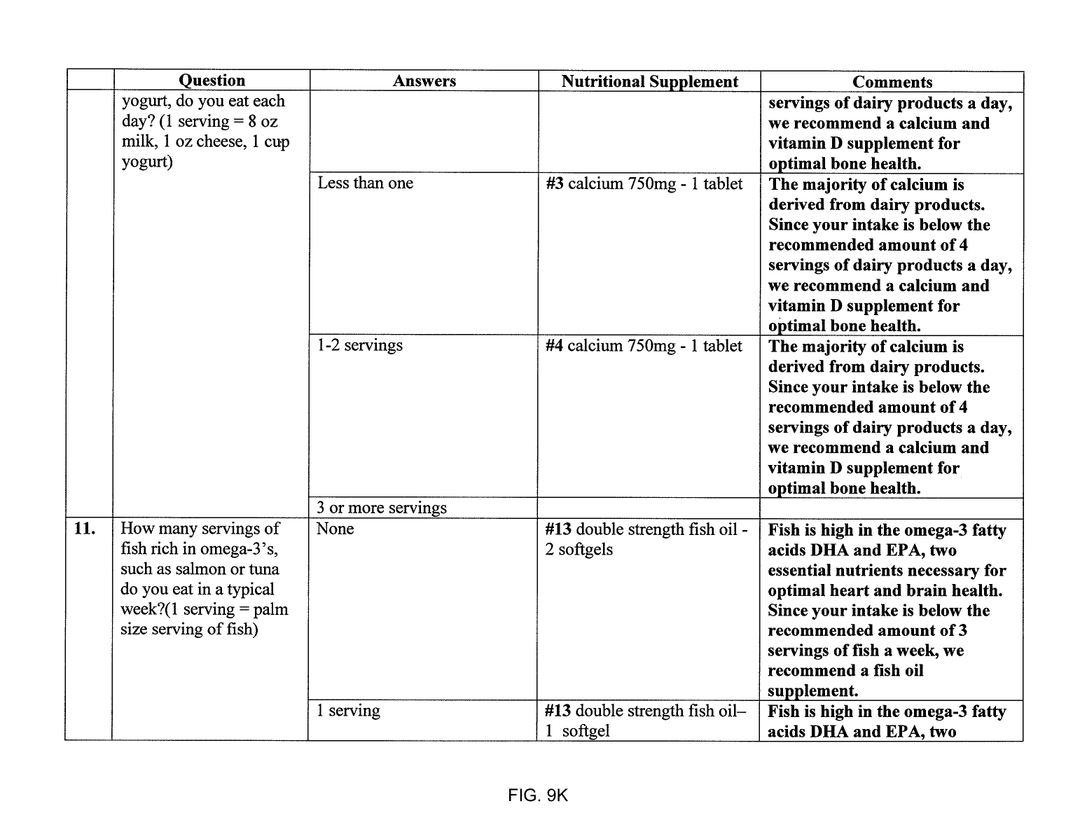

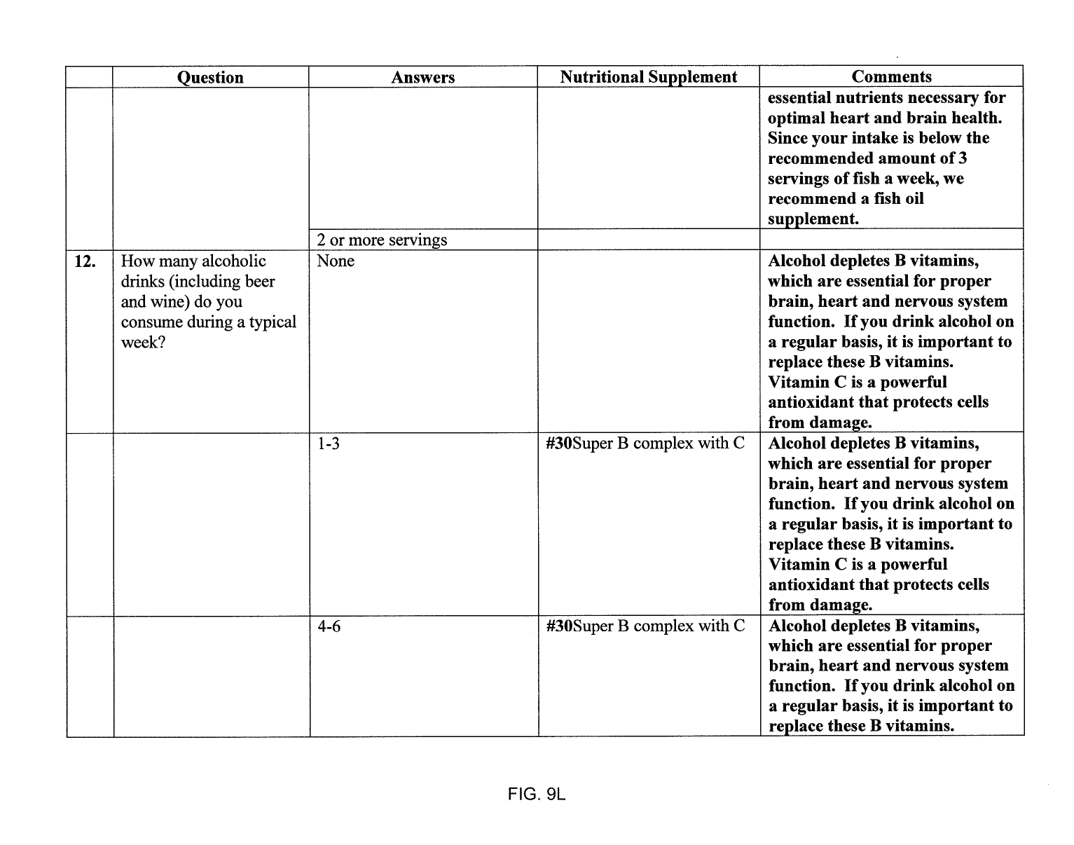

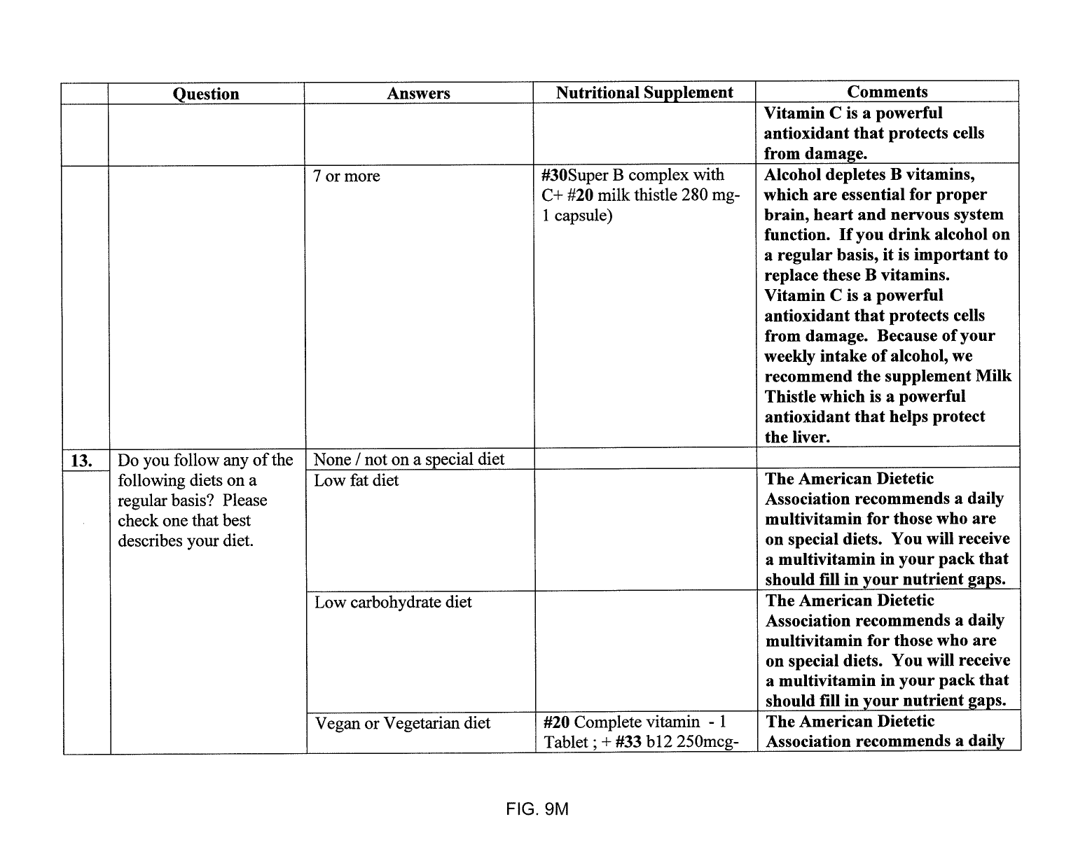

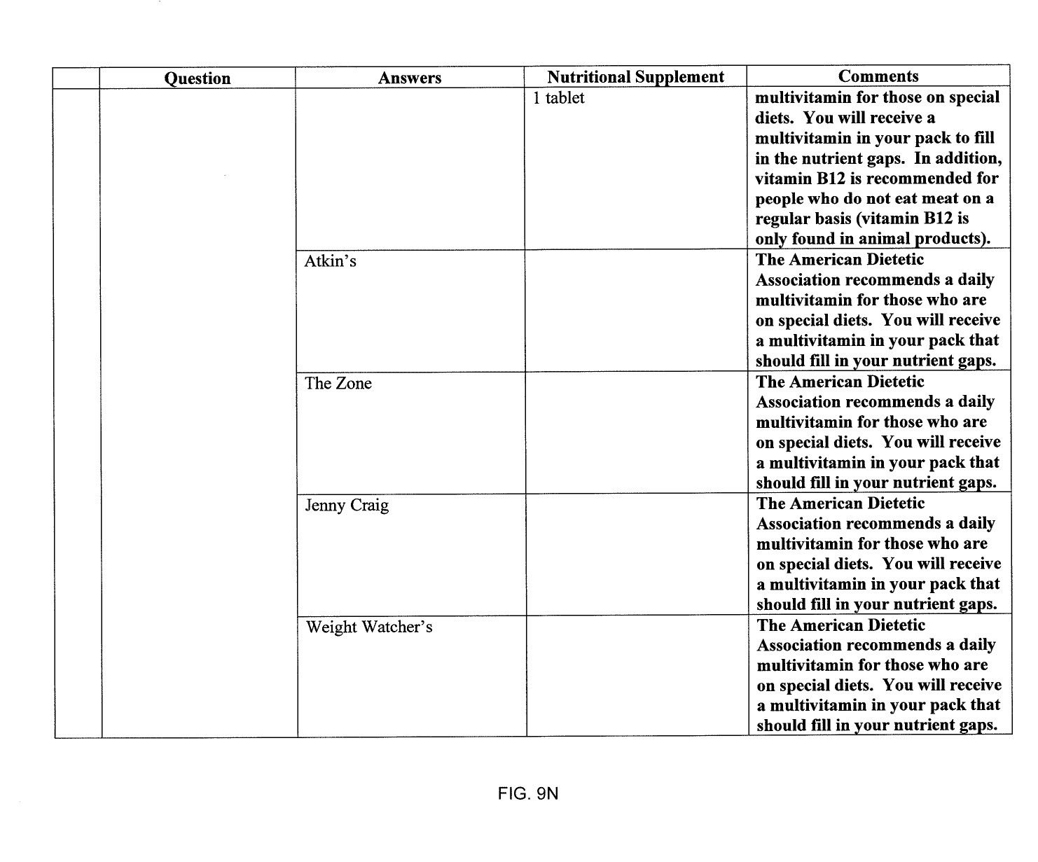

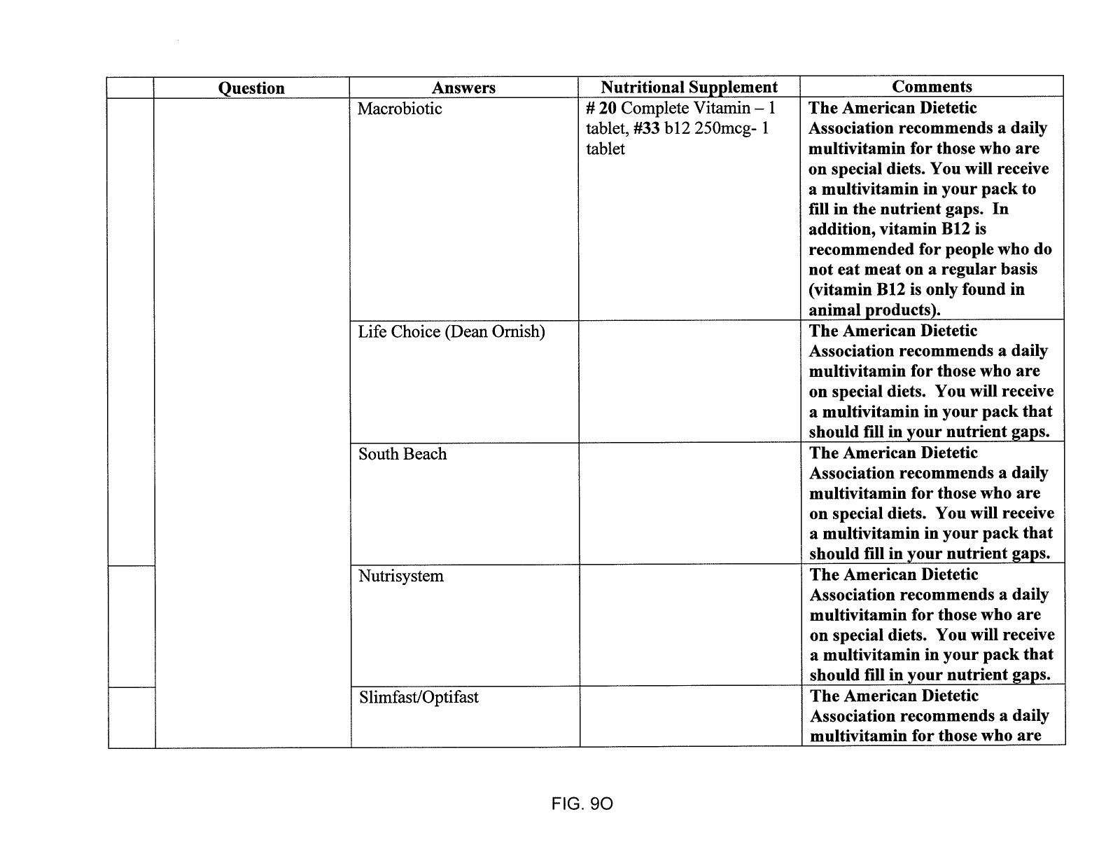

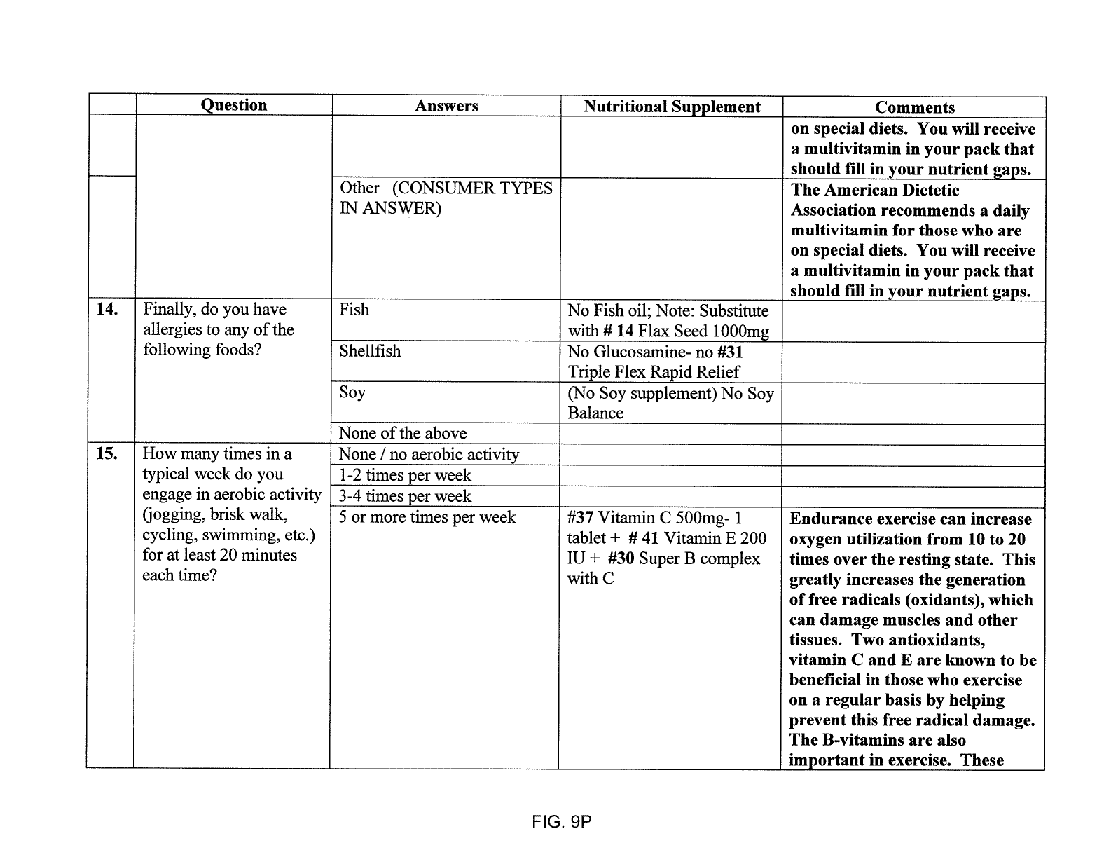

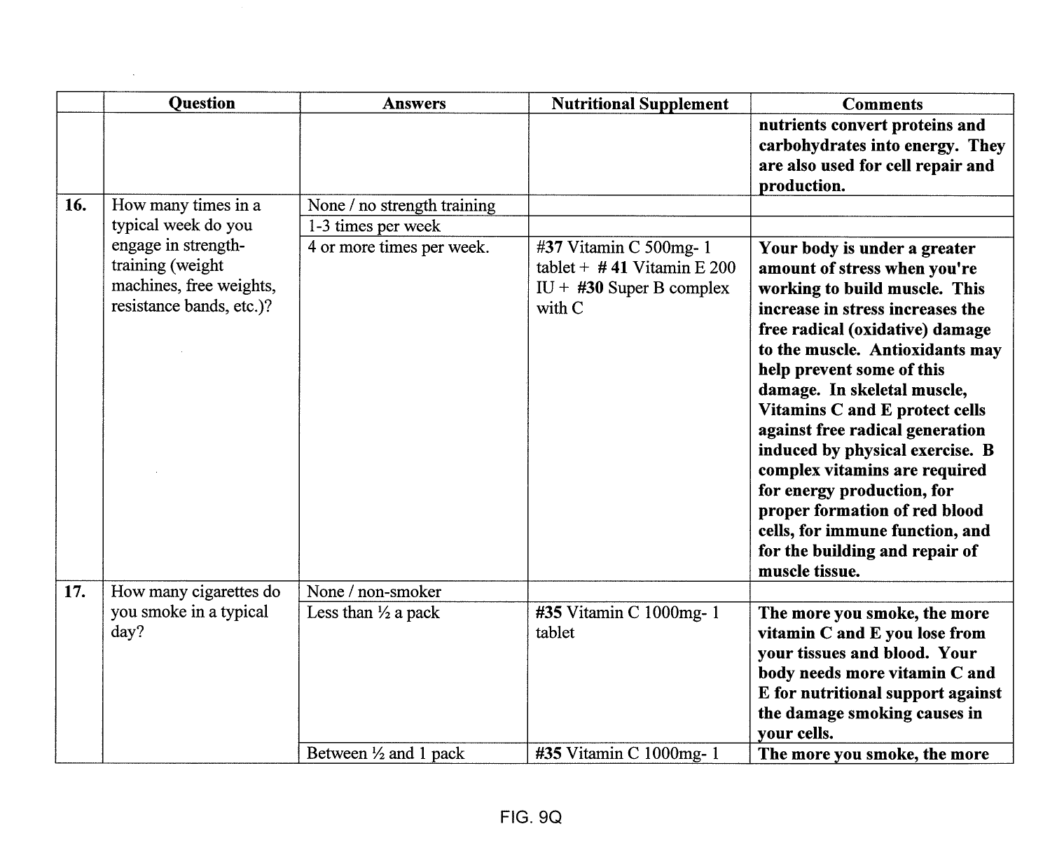

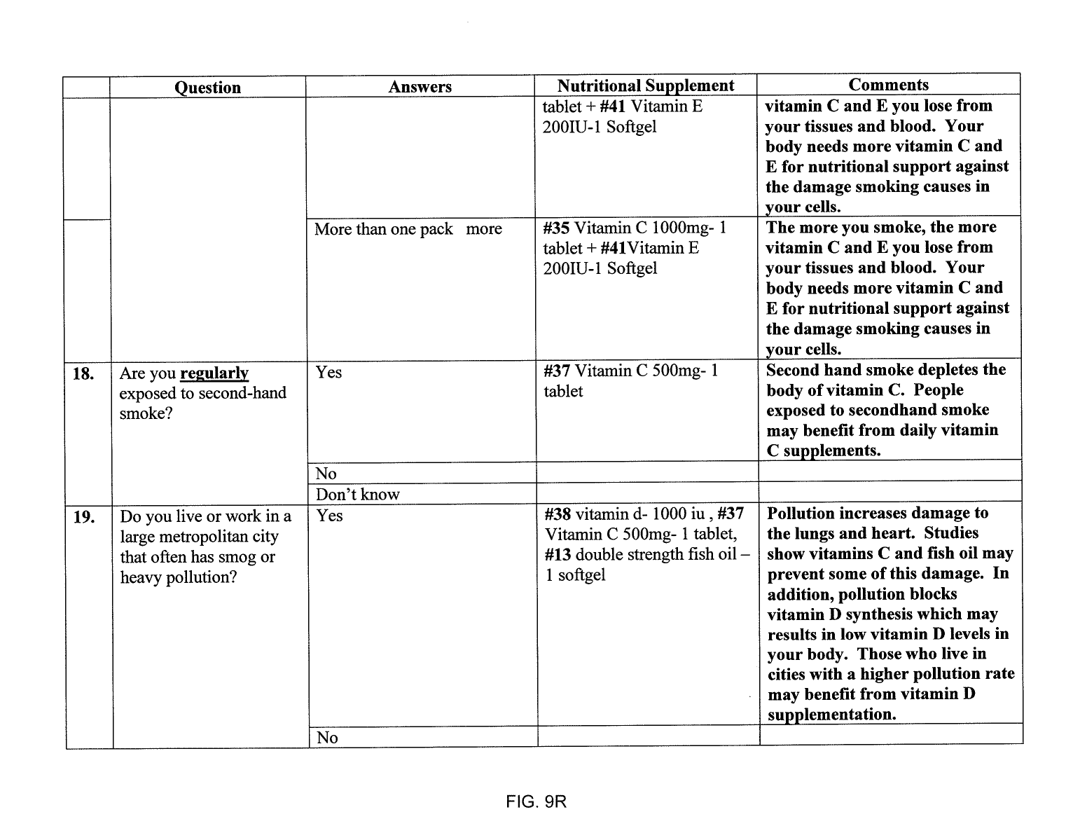

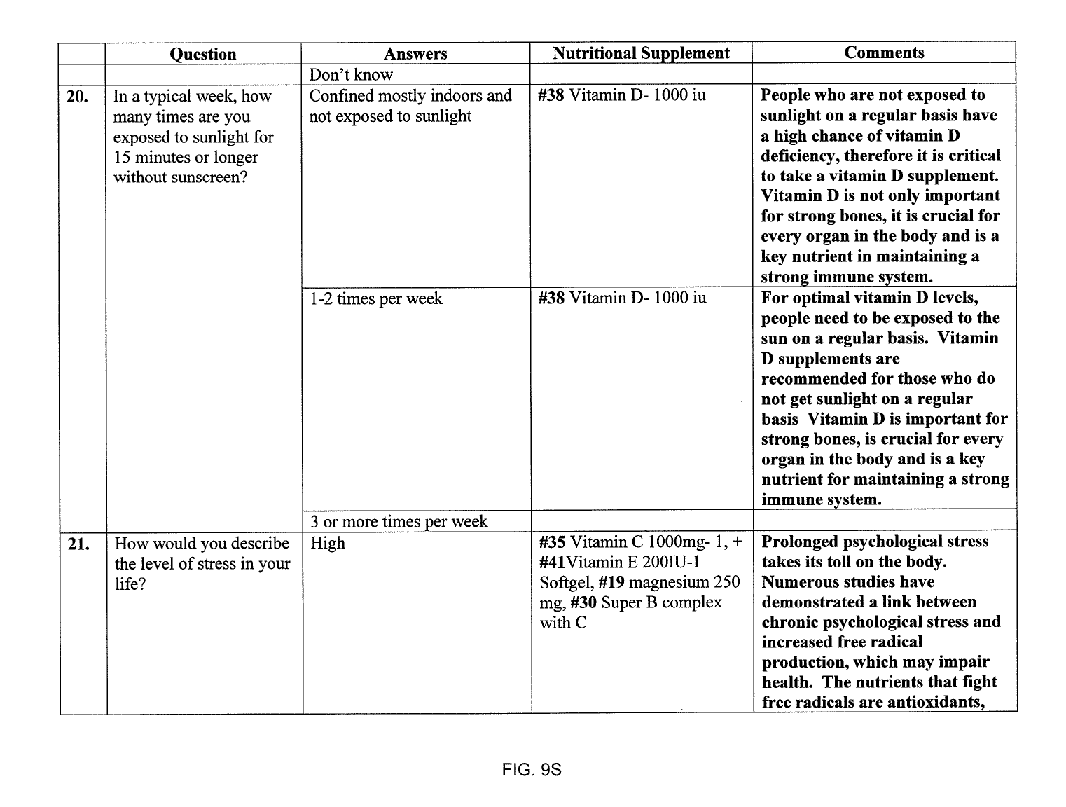

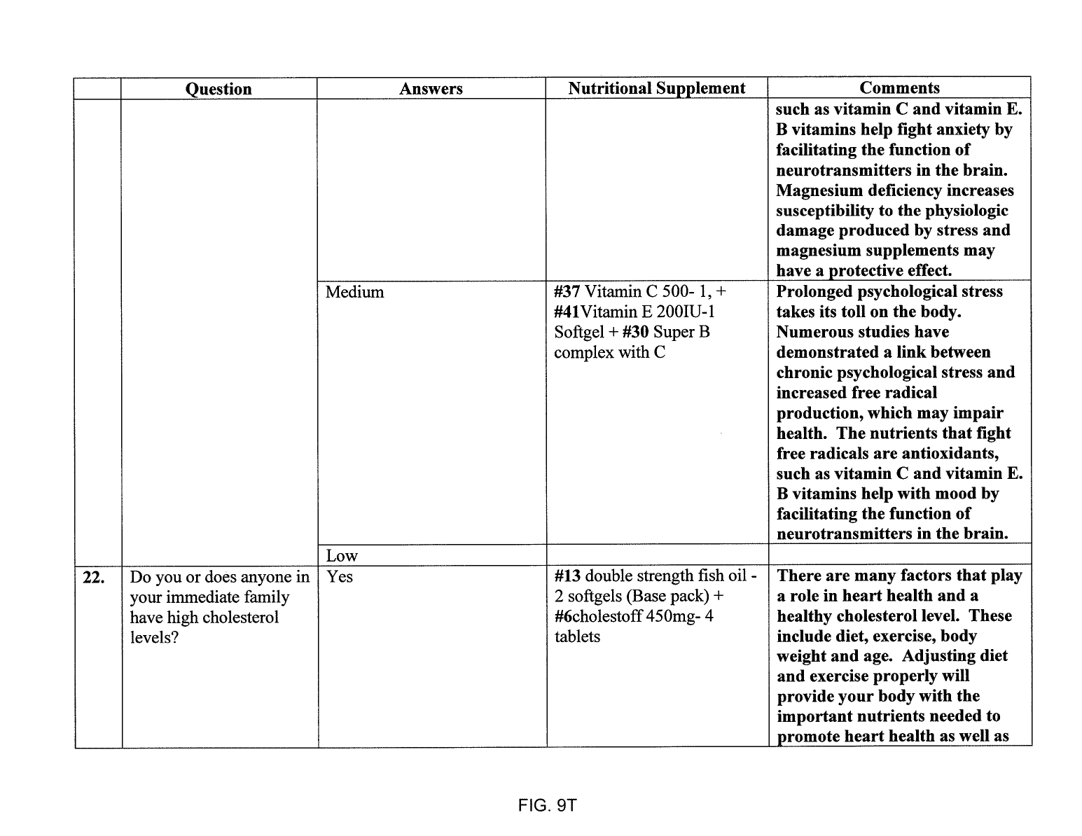

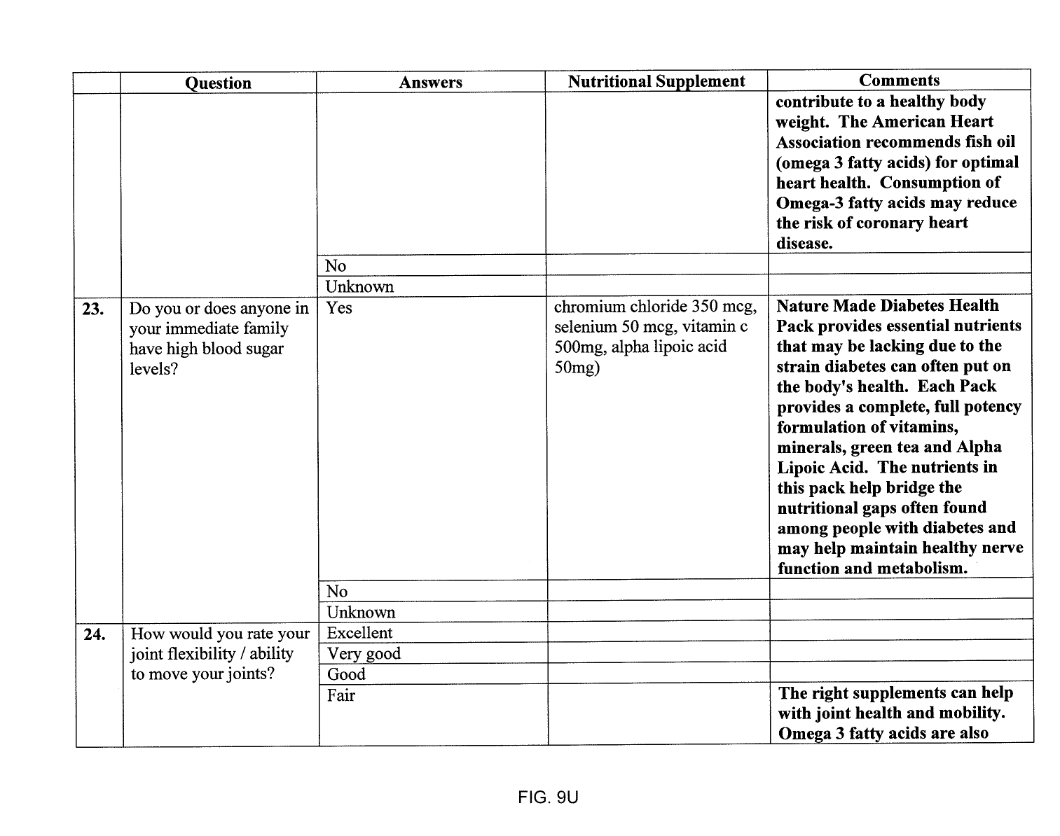

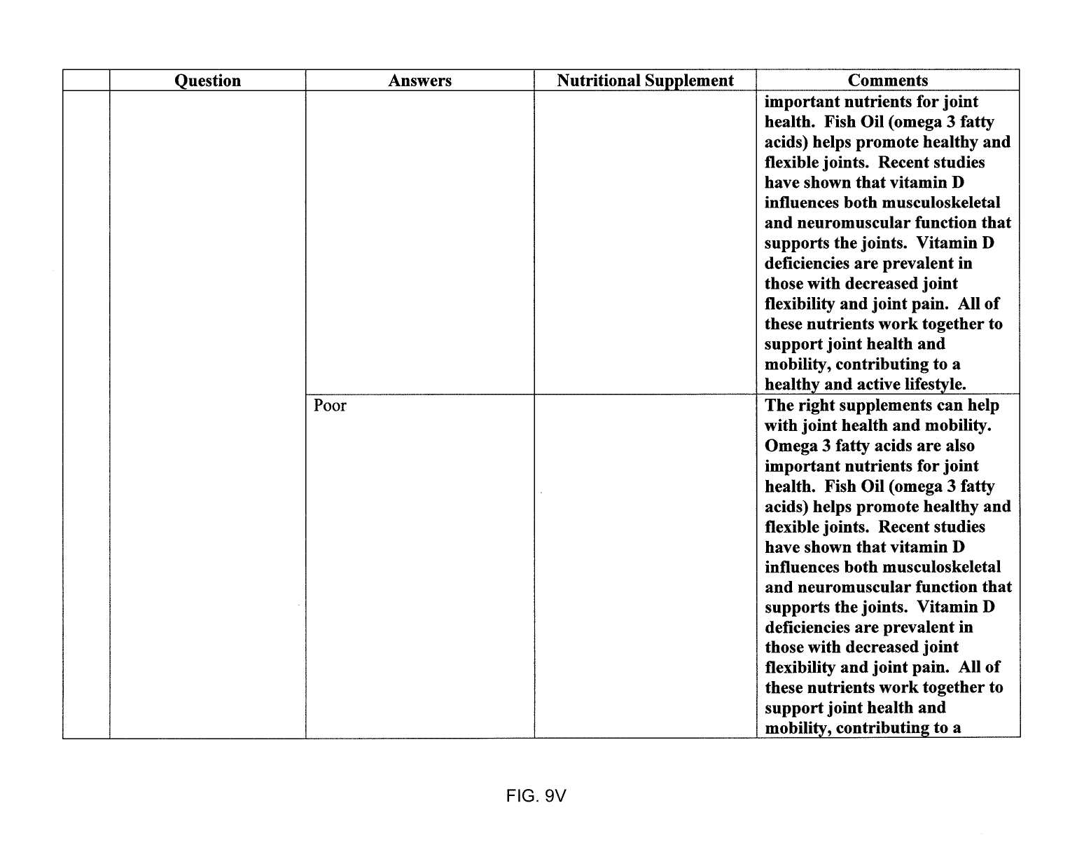

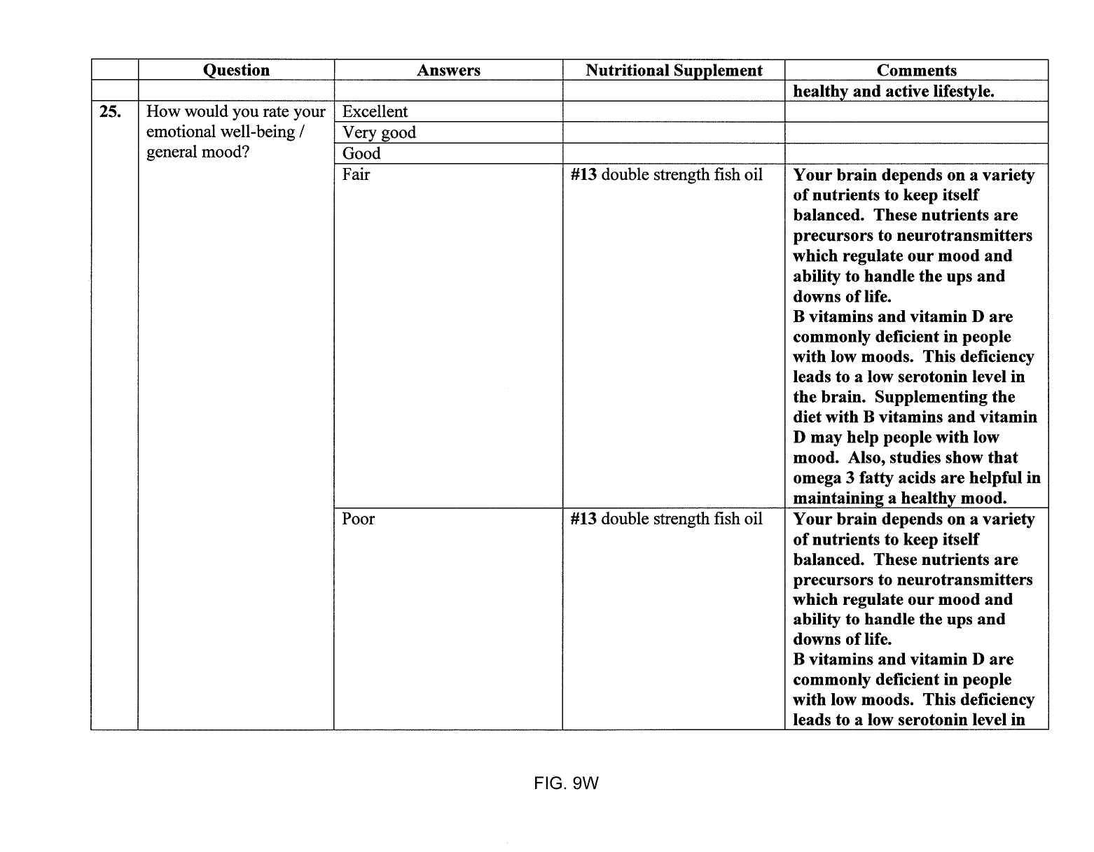

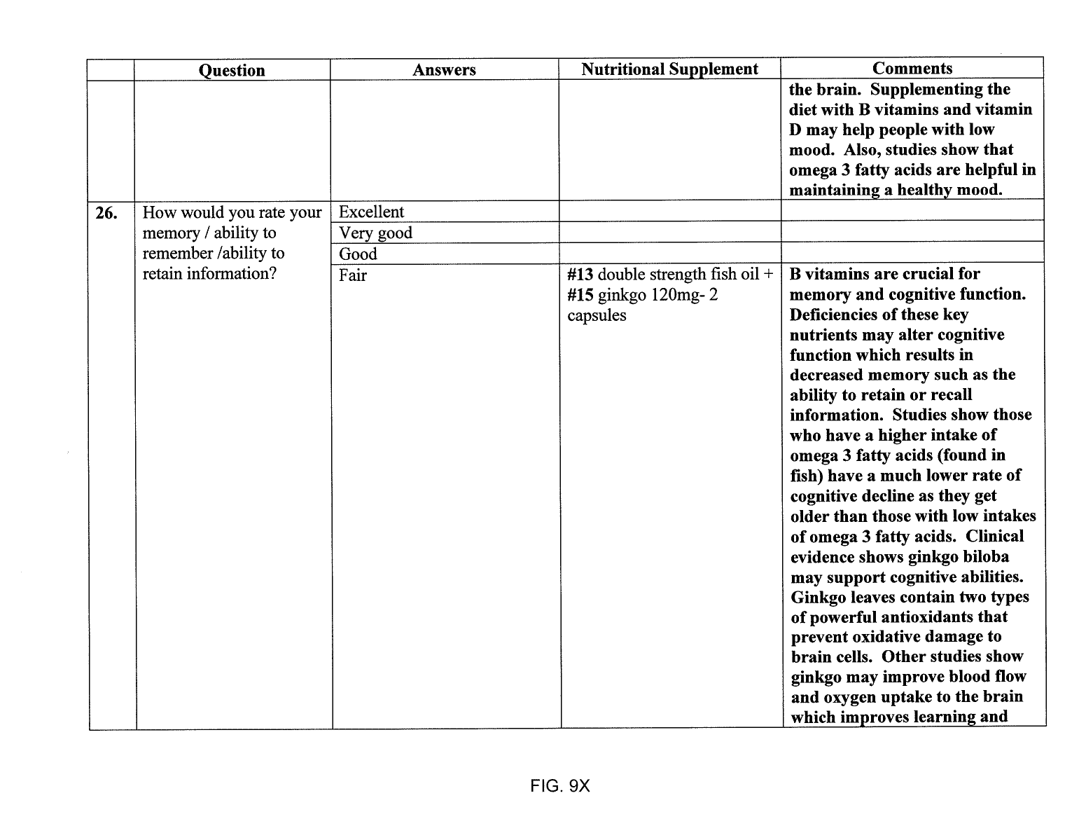

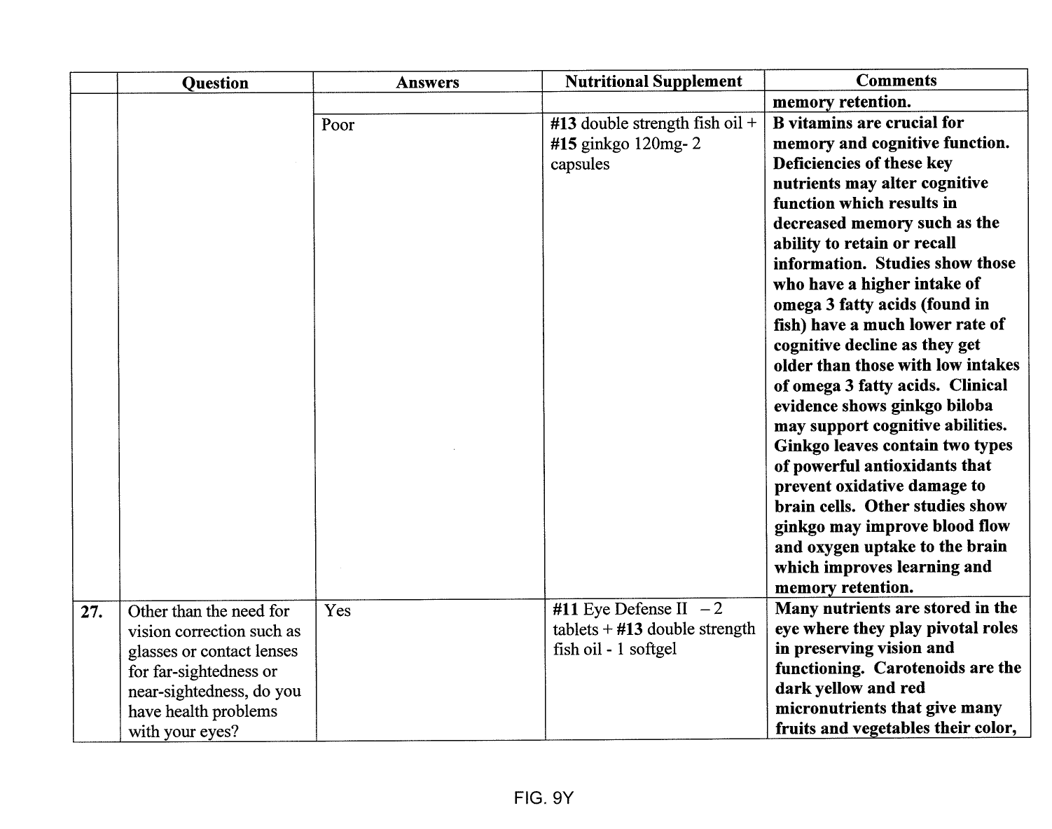

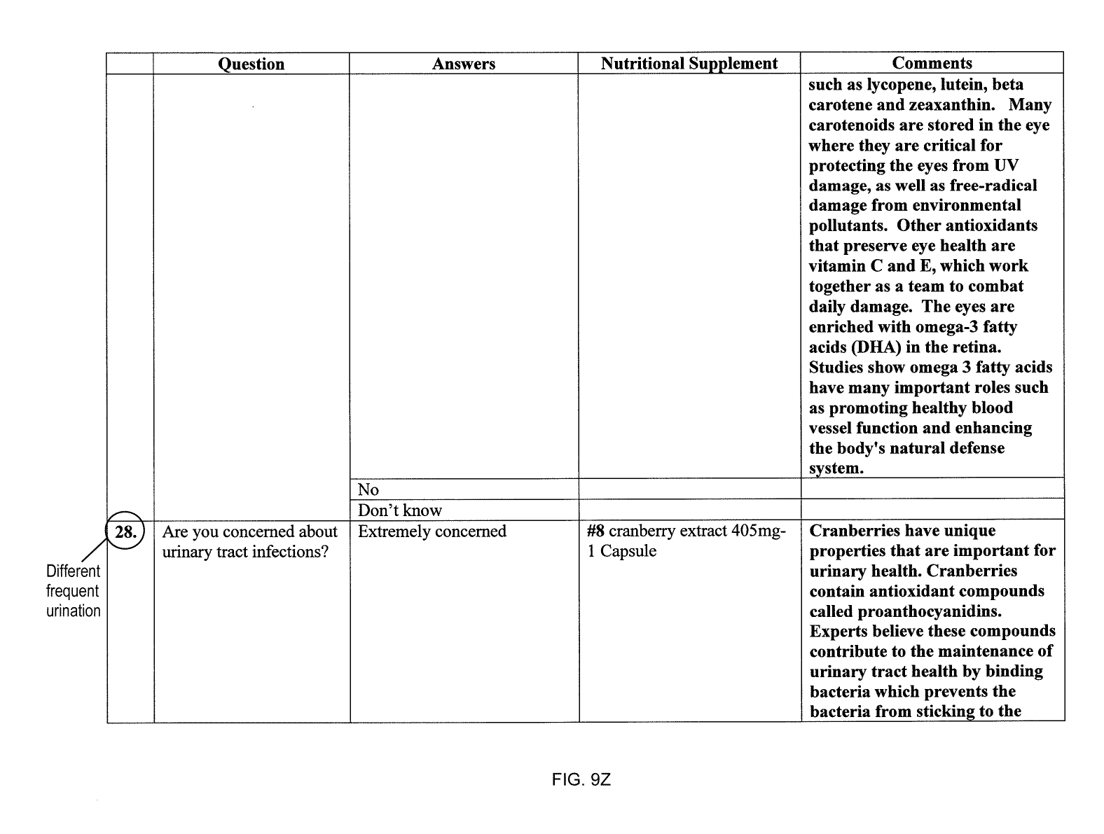

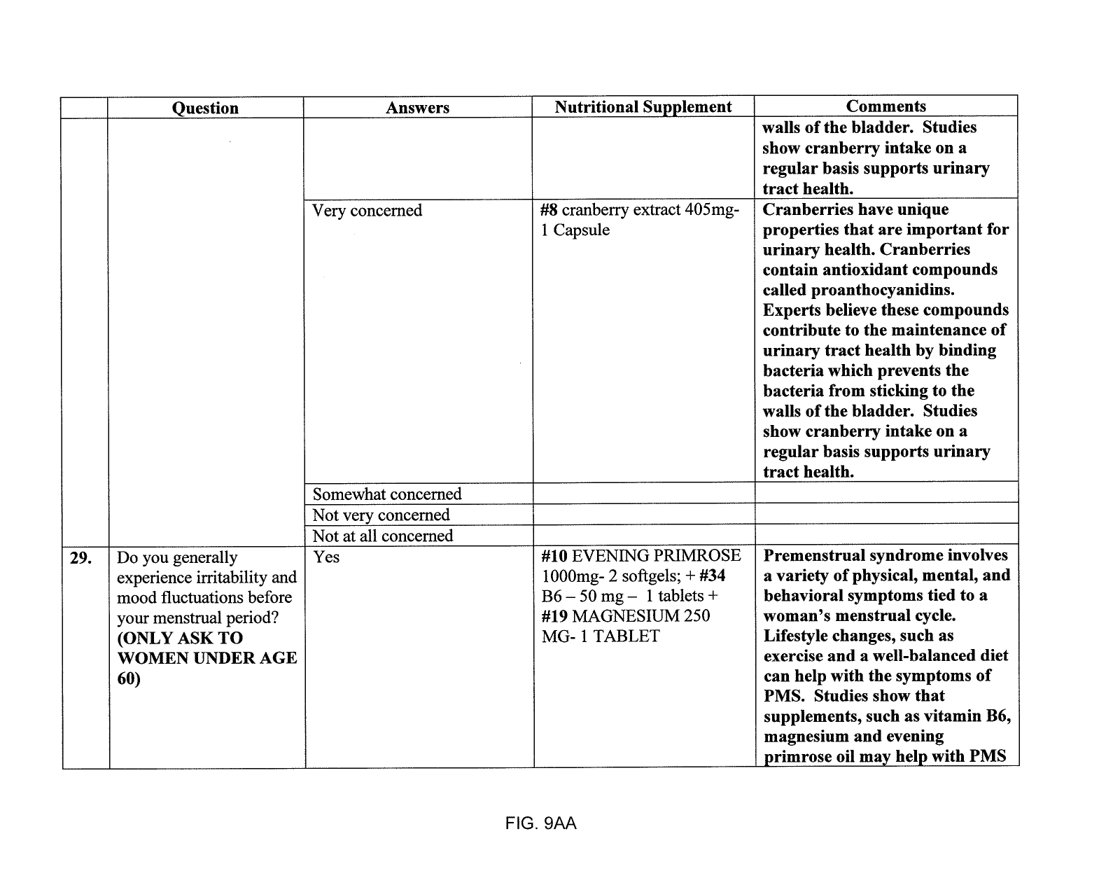

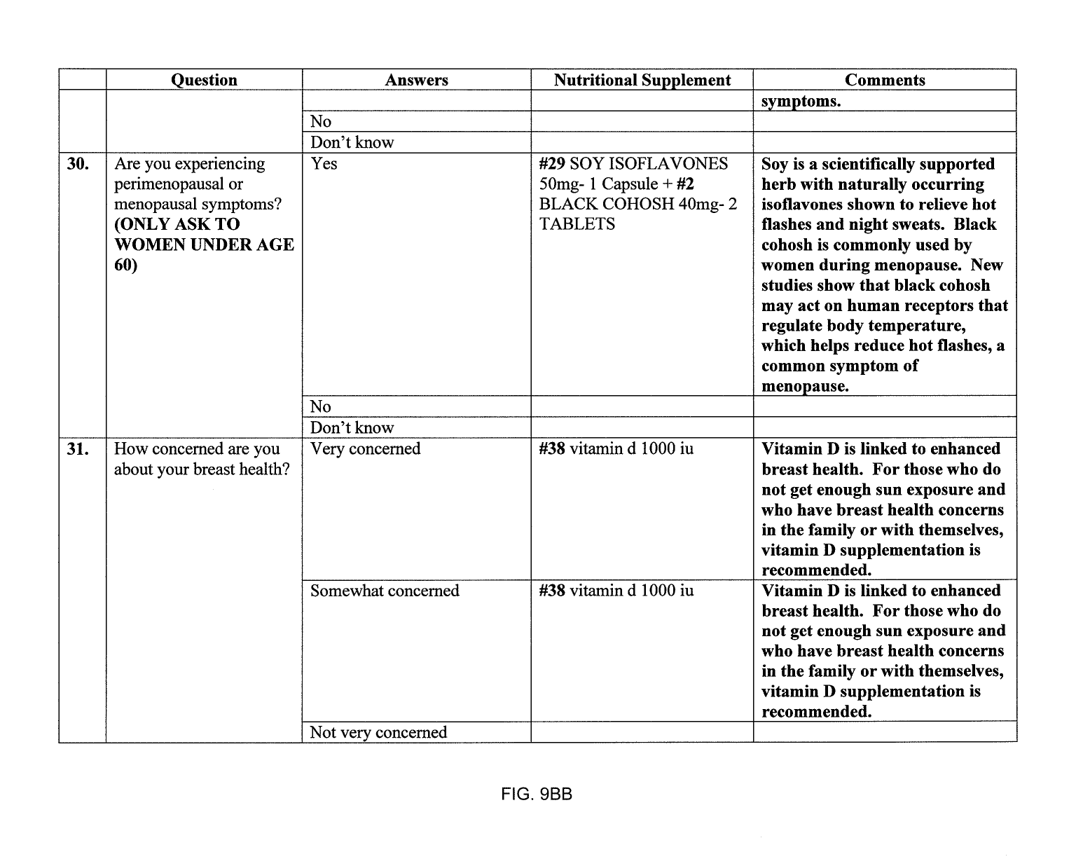

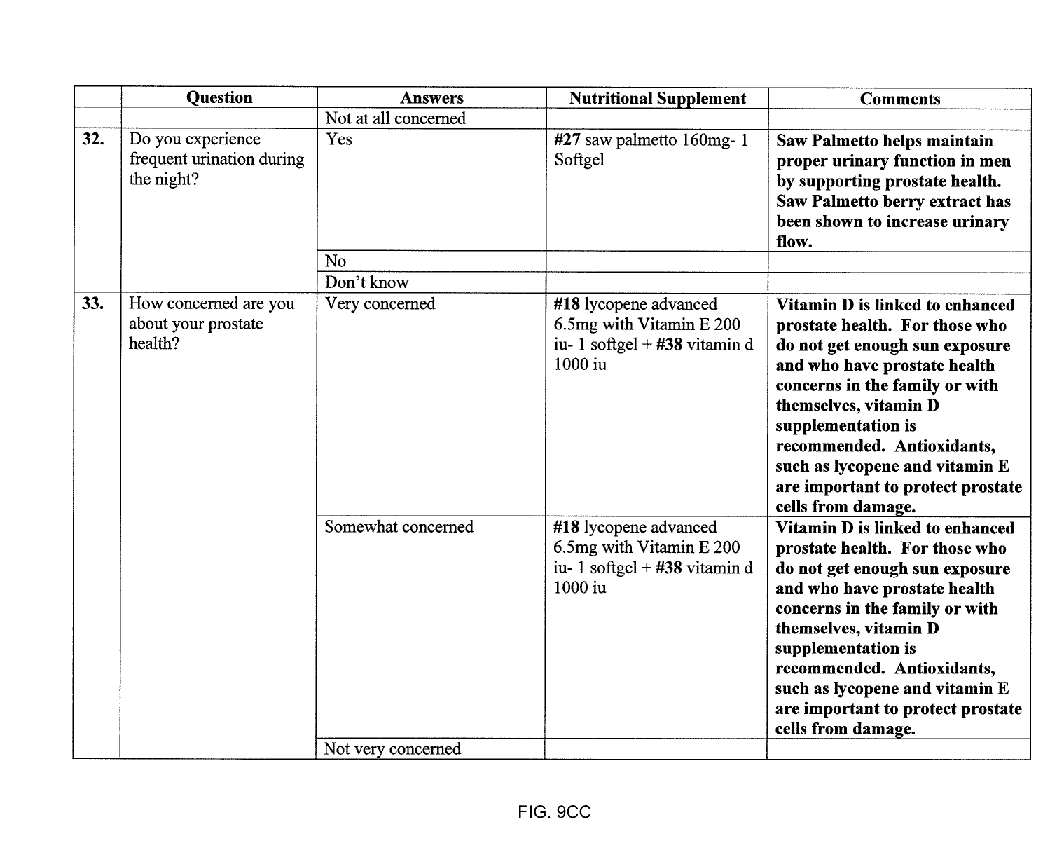

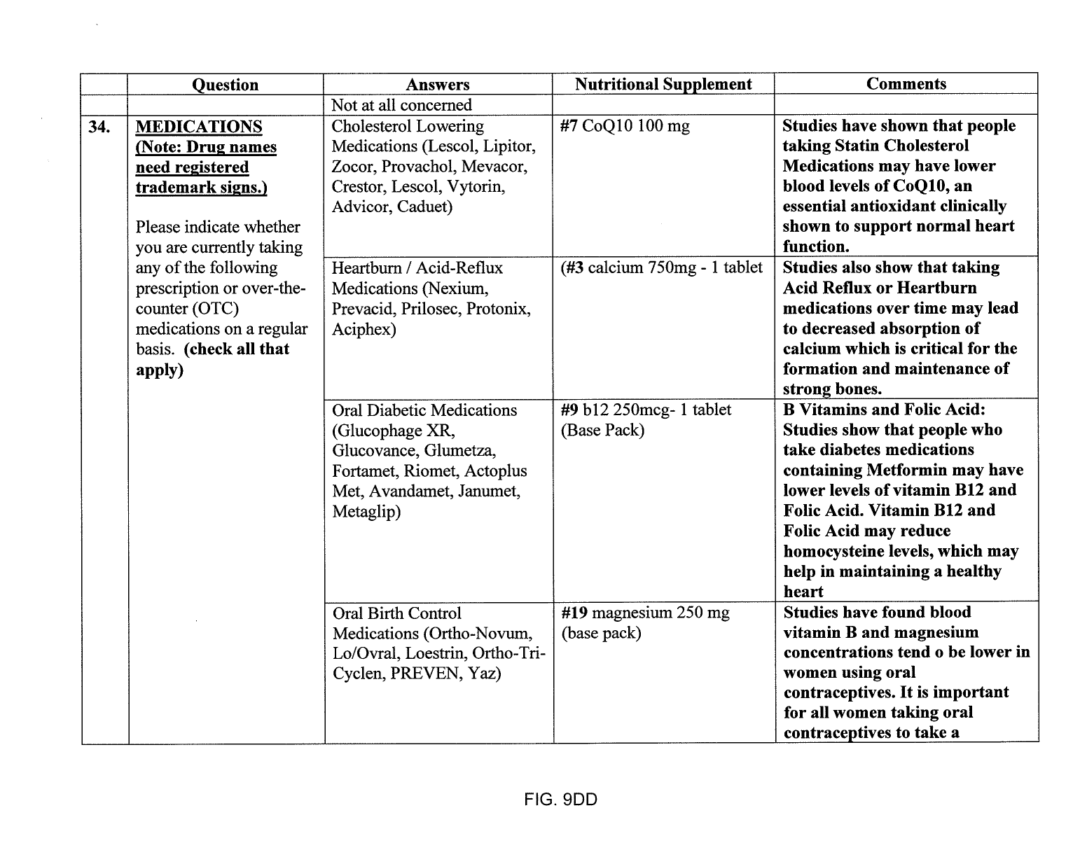

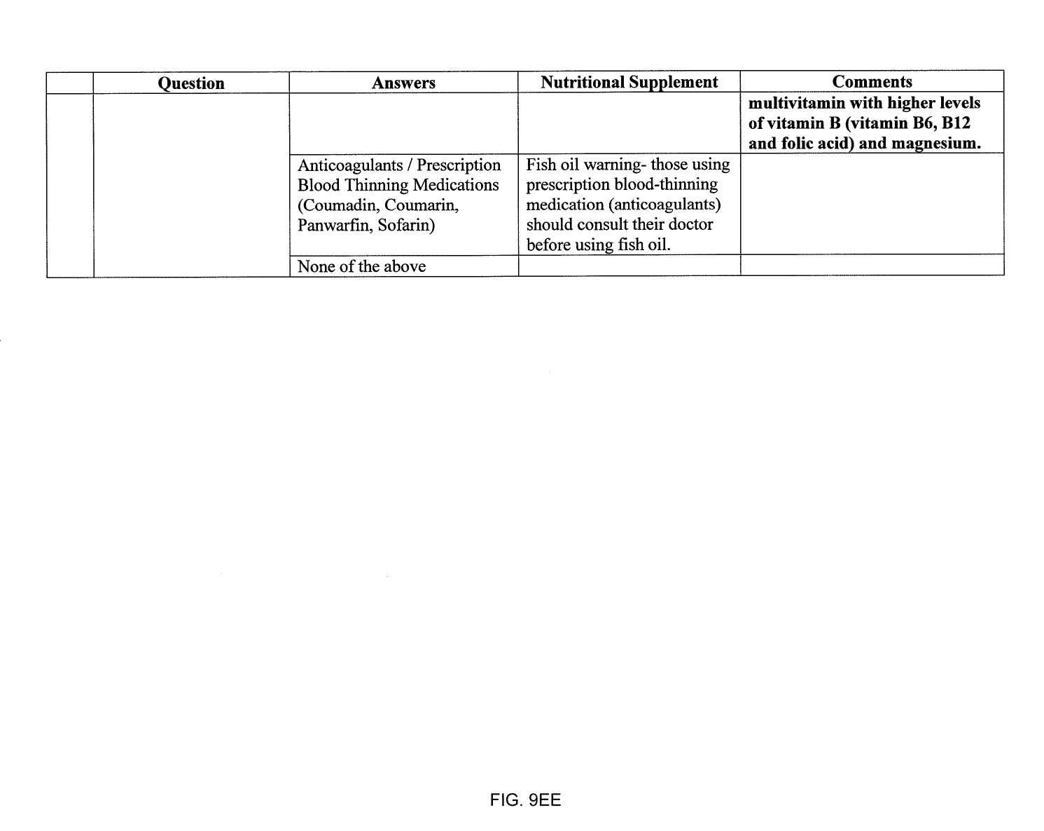

FIGS. 9A-9EE depicts an exemplary questionnaire. The exemplary questionnaire may be based on a algorithm such as, for example, the algorithms discussed in connection with FIGS. 2-4. The exemplary questionnaire contains exemplary questions as well as exemplary answers to each individual question. The exemplary questionnaire also lists nutritional supplements that are associated with each answer to each question. The exemplary questionnaire also lists potential comments and/or dietary suggestions which are associated with the nutritional supplement which is associated to the answer to a specific question.

1. A computer-implemented method for providing a daily nutritional supplement component regimen, the method comprising:
creating, at a first computer, a plurality of questions, each question regarding a health condition of a user, each question having at least two possible answers, each answer representing a qualitative or quantitative characteristic of the user's health condition, each health condition linked to a set of at least one predetermined recommended nutritional supplement components;
presenting the plurality of questions to the user on a second computer;
receiving at the first computer a user response to the plurality of questions, the first computer accepting one and only one response to each question;
identifying an original group of predetermined recommended nutritional supplement components at the first computer, each recommended nutritional supplement component being associated with a health condition of the user;
identifying at least one recommended nutritional supplement dosage form at the first computer based on the plurality of recommended nutritional supplement components; and
providing the user with a list of the at least one recommended nutritional supplement dosage form to the second computer.

2. The computer-implemented method of claim 1, comprising:
identifying any recommended nutritional supplement component that is an allergen for the user;
identifying any amount of a recommended nutritional supplement component that exceeds the recommended daily allowance of the user for the recommended nutritional supplement component;
identifying any recommended nutritional supplement component that violates a dietary restriction of the user;
removing any identified recommended nutritional supplement component or amount of recommended nutritional supplement component from the original group of nutritional supplement components and assembling a corrected group of nutritional supplement components;
selecting one or more dosage forms comprising the corrected group of nutritional supplement components; and
outputting the corrected group of nutritional supplement components and/or a list of dosage forms from the computer.

3. A method according to claim 1, wherein the health conditions comprise at least one of the following:
a physical condition;
a fitness condition; and
a lifestyle condition;

4. A method according to claim 1, wherein identifying the at least one recommended nutritional supplement component, further comprises:
identifying a multivitamin based on the gender of the user;
identifying a multivitamin based on the age of the user; and/or
identifying at least one specific nutritional supplement component.

5. A method according to claim 1, wherein the nutritional supplement component comprises at least one of:
an individual vitamin supplement component,
a mineral supplement component,
a herb supplement component,
a coenzymes (CoQ10) supplement component,
a fish oil supplement component, and
a physterols supplement component.

6. A method according to claim 1, wherein the at least one health condition is related to at least one of:
the age of the user;
the gender of the user;
the allergies of the user;
the eating habits of the user;
the alcohol consumption of the user;
the sugar consumption of the user;
the softdrink consumption of the user;
the caffeine consumption of the user;
the dietary restrictions of the user;
the family history of the user;
the medical history of the user;
medications taken by the user;
the calcium intake of the user;
the vitamin D intake of the user;
the pregnancy status of the user,
the lactation status of the user;
the premenstrual symptoms of the user;
the premenopausal symptoms of the user;
the menopausal symptoms of the user;
the breast cancer concerns of the user;
the urinary health concerns of the user; and
the prostate health concerns of the user.

7. A method according to claim 1, wherein the at least one health condition is related to at least one of:
exercise,
cardiovascular or strength training,
exposure to air pollution,
exposure to second-hand smoke,
sunlight,
smoking, or
stress.

8. A method according to claim 1 wherein the at least one health condition is related to at least one of:
user's over all health,
eye health,
respiratory health,
mood/emotional well-being,
memory/retention, and
joint health.

9. A method according to claim 1, comprising updating, at the first computer, the association between nutritional supplement components and health conditions based on at least one of:
at regular intervals;
each time the knowledge base is updated; and
each time a supplement component is added/removed.

10. A method according to claim 1, wherein additional questions are asked or are not asked in the questionnaire based on the user's response to previous questions.

11. A method according to claim 1, wherein identifying the at least one recommended nutritional supplement component comprises:
correcting for the allergens of the user;
correcting for a violation of a maximum daily allowable intake of the user;
correcting for the dietary preferences of the user; and
identifying combination nutritional supplement dosage forms comprising nutritional supplement components.

12. A method according to claim 1, comprising:
building a nutritional supplement component knowledge base at a first computer;
identifying at least one nutritional supplement component based on the knowledge base at the first computer.

13. A method according to claim 1, wherein at least one recommended nutritional supplement dosage form is a multivitamin and at least one recommended nutritional supplement dosage form combines a first nutritional supplement component and a second nutritional supplement component.

14. A method according to claim 1, wherein selecting a plurality of recommended nutritional supplement dosage forms comprises selecting no more than ten nutritional supplement dosage forms.

15. A method according to claim 1, comprising automatically directing a dispensing device to dispense the at least one dosage form.

16. A method according to claim 1, wherein the dispensing device comprises:
a plurality of containers, each container containing a plurality of nutritional supplement dosage forms of a single type;
a dispenser coupled to each of the containers, each dispenser adapted to dispense a nutritional supplement into a common package on command;
a controller coupled to each dispenser and adapted to command one or more dispensers to dispense a nutritional supplement into the common package;
a nutritional supplement dosage form packaging module adapted to package at least one recommended nutritional supplement dosage form selected from a plurality of available nutritional supplement dosage forms contained in the nutritional supplement dosage form packaging module into a plurality of daily nutritional supplement dosage form packages;
wherein the controller receives an outputted list of dosage forms from the computer in claim 1 and controls the dispensers accordingly.

17. A nutritional supplement component dosage form kit comprising:
a plurality of daily nutritional packets, personalized to an individual person, each of the daily nutritional packets containing at least one nutritional supplement dosage form, each nutritional supplement dosage form selected by a computer-implemented method for customizing a recommended nutritional supplement dosage form regimen, the method comprising the steps of claims 16, wherein each of the at least one nutritional supplement dosage forms of the kit are linked to an answer to a question about a health condition of the person.

18. An apparatus comprising:
one or more computer input devices operable to receive data;
a storage device operable to maintain a question-answer-nutritional supplement map;
a processor configured to generate a dietary supplement regimen in response to answers to health condition questions provided at the input device, the regimen including a plurality of nutritional supplement components, each component being associated with a particular health condition; and
an output device configured to deliver the regimen.

19. An apparatus according to claim 18, comprising a dispensing device configured to dispense the dietary supplements of the regimen.

20. An apparatus according to claim 19, comprising
a plurality of containers, each container adapted to contain a plurality of nutritional supplement dosage forms of a single type;
a dispenser coupled to each of the containers, each dispenser adapted to dispense a nutritional supplement into a common package on command;
a controller coupled to each dispenser and adapted to command one or more dispensers to dispense a nutritional supplement into the common package;
a nutritional supplement dosage form packaging module adapted to package at least one recommended nutritional supplement dosage form selected from a plurality of available nutritional supplement dosage forms contained in the nutritional supplement dosage form packaging module into a plurality of daily nutritional supplement dosage form packages;
wherein the controller receives an outputted list of dosage forms from the computer in claim 1 and controls the dispensers accordingly.

21. An apparatus according to claim 18 comprising a non-transitory computer-readable storage medium with an executable program stored thereon, wherein the program instructs the processor to perform the following steps of generating a dietary supplement regimen:
creating, at a first computer, a plurality of questions, each question regarding a health condition of a user, each question having at least two possible answers, each answer representing a qualitative or quantitative characteristic of the user's health condition, each health condition linked to a set of at least one predetermined recommended nutritional supplement components;
presenting the plurality of questions to the user on a second computer via the input device;
receiving at the first computer a user response to the plurality of questions, the first computer accepting one and only one response to each question;
identifying an original group of predetermined recommended nutritional supplement components at the first computer, each recommended nutritional supplement component being associated with a health condition of the user; and
identifying at least one recommended nutritional supplement dosage form at the first computer based on the plurality of recommended nutritional supplement components.

22. A non-transitory computer-readable storage medium with an executable program stored thereon, wherein the program instructs a microprocessor to perform the following steps of generating a dietary supplement regimen:
creating, at a first computer, a plurality of questions, each question regarding a health condition of a user, each question having at least two possible answers, each answer representing a qualitative or quantitative characteristic of the user's health condition, each health condition linked to a set of at least one predetermined recommended nutritional supplement components;
presenting the plurality of questions to the user on a second computer via the input device;
receiving at the first computer a user response to the plurality of questions, the first computer accepting one and only one response to each question;
identifying an original group of predetermined recommended nutritional supplement components at the first computer, each recommended nutritional supplement component being associated with a health condition of the user; and
identifying at least one recommended nutritional supplement dosage form at the first computer based on the plurality of recommended nutritional supplement components.
